(19) United States
(12) Patent Application Publication
(10) Pub. No.: US 2010/0043980 A1
(43) Pub. Date: Feb. 25, 2010

(54) ALIGNMENT MECHANISM FOR ALIGNING AN INTEGRATED CIRCUIT

(75) Inventors: Stephen John Sleijpen, Balmain (AU); James Andrew, Balmain (AU); Graeme Kenneth Bowyer, Balmain (AU); William Granger, Balmain (AU); Jan Waszczuk, Balmain (AU); David Oliver Burke, Balmain (AU); Craig Donald Strudwicke, Balmain (AU); Jason Mark Thelander, Balmain (AU)

Correspondence Address: SILVERBROOK RESEARCH PTY LTD, 393 DARLING STREET, BALMAIN, 2041, AU

(73) Assignee: SILVERBROOK RESEARCH PTY LTD

(21) Appl. No.: 12/193,733

(22) Filed: Aug. 19, 2008

(51) Int. Cl. B32B 37/00

(52) U.S. Cl. 156/378

(57) ABSTRACT

Provided is an alignment mechanism for aligning a lamination film with a carrier substructure prior to laminating the film to the substructure to form a carrier for integrated circuits. The substructure and the lamination film define complementary perforations and a plurality of respective fiducials. The alignment mechanism includes a sensor arrangement configured to detect the fiducials in the lamination film and substructure and a displacement mechanism configured to displace the lamination film with respect to the substructure to align the perforations of the film and substructure respectively according to alignment of their fiducials so that a printing fluid can pass through the perforations in the film and the substructure of the carrier. The mechanism also includes a controller configured to control operation of the sensor arrangement and the displacement mechanism.

### FIELD OF INVENTION

The invention relates to the field of printing, in general. More specifically, the invention provides for a laminating apparatus for laminating a printhead integrated circuits (IC) carrier sub-assembly; a method for laminating a carrier for printhead integrated circuits; a safety system for an apparatus used to bond an integrated circuit carrier film to a base assembly of a carrier used for testing integrated circuits; a bonding apparatus for bonding a carrier sheet used for carrying printhead integrated circuits to be tested to a carrier base; and an alignment mechanism for aligning a lamination film with a carrier substructure prior to laminating the film to the substructure to form a carrier for integrated circuits.

### CO-PENDING APPLICATIONS

The following applications have been filed by the Applicant simultaneously with the present application:

| | | | | | | |
|---|---|---|---|---|---|---|
| MPN023US | MPN024US | MPN025US | MPN026US | MPN027US | MPN028US | MPN029US |
| MPN030US | MPN031US | MPN032US | MPN033US | MPN034US | MPN035US | MPN036US |
| MPN037US | MPN038US | MPN039US | MPN041US | MPN043US | MPN046US | MPN047US |
| MPN048US | MPN049US | MPN051US | MPN052US | MPN053US | MPN054US | MPN055US |
| MPN056US | MPN057US | MPN058US | MPN059US | MPN060US | MPN061US | |

The disclosures of these co-pending applications are incorporated herein by reference. The above applications have been identified by their filing docket number, which will be substituted with the corresponding application number, once assigned.

### CROSS REFERENCES

The following patents or patent applications filed by the applicant or assignee of the present invention are hereby incorporated by cross-reference.

| | | | | | | |
|---|---|---|---|---|---|---|
| 11/246687 | 11/246718 | 7322681 | 11/246686 | 11/246703 | 11/246691 | 11/246711 |
| 11/246690 | 11/246712 | 11/246717 | 7401890 | 7401910 | 11/246701 | 11/246702 |
| 11/246668 | 11/246697 | 11/246698 | 11/246699 | 11/246675 | 11/246674 | 11/246667 |
| 11/829957 | 11/829960 | 11/829961 | 11/829962 | 11/829963 | 11/829966 | 11/829967 |
| 11/829968 | 11/829969 | 11946839 | 11946838 | 11946837 | 11951230 | 12141034 |
| 12140265 | 12183003 | 11/688863 | 11/688864 | 11/688865 | 7364265 | 11/688867 |
| 11/688868 | 11/688869 | 11/688871 | 11/688872 | 11/688873 | 11/741766 | 12014767 |
| 12014768 | 12014769 | 12014770 | 12014771 | 12014772 | 12014773 | 12014774 |
| 12014775 | 12014776 | 12014777 | 12014778 | 12014779 | 12014780 | 12014781 |
| 12014782 | 12014783 | 12014784 | 12014785 | 12014787 | 12014788 | 12014789 |
| 12014790 | 12014791 | 12014792 | 12014793 | 12014794 | 12014796 | 12014798 |
| 12014801 | 12014803 | 12014804 | 12014805 | 12014806 | 12014807 | 12049371 |
| 12049372 | 12049373 | 12049374 | 12049375 | 12103674 | 12146399 | |

### BACKGROUND

Pagewidth printers that incorporate micro-electromechanical components generally have printhead integrated circuits that include a silicon substrate with a large number of densely arranged micro-electromechanical nozzle arrangements. Each nozzle arrangement is responsible for ejecting a stream of ink drops.

In order for such printers to print accurately and maintain quality, it is important that the printhead integrated circuits be tested. This is particularly important during the design and development of such integrated circuits.

Some form of carrier is generally required for testing such integrated circuits. The carrier is required to be suitable for the attachment of printhead integrated circuits.

### SUMMARY

According to a first aspect of the invention there is provided a laminating apparatus for laminating a printhead integrated circuit (IC) carrier sub-assembly and a lamination film, said apparatus comprising:

a lamination support for receiving the carrier;

a lamina supply for supplying a lamina defining said lamination film;

an alignment mechanism configured to align the lamination film with the IC carrier sub-assembly;

a bonding apparatus configured to bond the lamination film to the IC carrier sub-assembly; and

a control system to control operation of the lamina supply, alignment mechanism and bonding apparatus to facilitate automatic bonding of the lamination film to the surface of the carrier.

The lamina supply may include a lamina film reel on which the lamina is stored and a film gripper assembly to grip the lamina for positional adjustment by the alignment mechanism.

The lamina supply may be configured to supply a lamina selected from the group consisting of: a thermosetting adhesive film, a polyimide carrier with adhesive on both sides thereof, and film with a polyethylene terephthalate (PET) liner.

The alignment mechanism may include a digital camera arrangement to sense relative positions of fiducials on the carrier sub-assembly and the lamination film.

The alignment mechanism may include actuators configured to displace the lamination support relative to the supplied lamina to facilitate alignment of the fiducials.

The bonding assembly may include a heated lamination plate to bond the supplied lamina thermally to the carrier sub-assembly.

The bonding assembly may include two film reels positioned on opposite sides of the heated lamination plate to dispense a thermal interface tape across said plate to facilitate uniform heat and pressure distribution during bonding.

The control system may include an operator interface allowing an operator to control the laminating apparatus.

The apparatus may include a cutting mechanism for cutting excess lamina from the carrier sub-assembly to minimize subsequent particulate contamination of carriers prior to bonding.

According to a second aspect of the invention there is provided a method for laminating a carrier for printhead integrated circuits, said carrier including a plurality of fiducials, the method comprising the steps of:

receiving the carrier in a cradle platform;

aligning each said fiducial with respective fiducials in a lamina having a series of such holes therein; and

bonding the aligned lamina to the carrier, so that a printing fluid is able to pass through the laminated apertures after such bonding.

The step of receiving the carrier may include receiving a carrier molded from a liquid crystal polymer (LCP).

The step of receiving the carrier may include receiving a carrier having a plurality of discrete fluid paths terminating in the surface of the carrier to define said respective fiducials.

The method may include a step of supplying the lamina from a spool.

The step of supplying the lamina may include de-ionizing the lamina with a de-ionizer to reduce electrostatic charge on the lamina prior to bonding.

The step of aligning may include sensing relative positions of the fiducials and displacing the lamina with respect to the carrier to align the fiducials.

The step of bonding may include thermally bonding the lamina to the carrier.

The step of bonding may include supplying a thermal interface material between a bonding assembly and the carrier to ensure uniform heat distribution during bonding.

The method may include a step of cutting excess lamina from the carrier.

The step of cutting may include cutting with an ultrasonic knife to minimize subsequent particulate contamination of carriers prior to bonding.

According to a third aspect of the invention there is provided a safety system for an apparatus used to bond an integrated circuit carrier film to a base assembly of a carrier used for testing integrated circuits, the apparatus including fluid-driven actuators for actuating movable components, heating circuits for heating bonding components within an operational zone and an electrical power supply, said system comprising:

a sensor arrangement for sensing an operational status of the apparatus;

an emergency cut-off configured to deactivate the apparatus when an undesired operational status is sensed; and

a controller operatively connected to both the sensor arrangement and the emergency cut-off to control operation thereof.

The sensor arrangement may be configured to sense an operational status selected from the group consisting of: a position of at least one of the movable components of the laminator; a temperature of at least one of the bonding components of the laminator; a presence of a foreign object proximate a movable or heated component; a fluid pressure of the actuators; a presence of the base assembly; authenticity of the base assembly; a presence of the integrated circuit carrier film; an alignment of the base assembly with the integrated circuit carrier film; and the electrical power supply.

The sensor arrangement may include a plurality of micro-switches for sensing the position of the movable components.

The sensor arrangement may include a temperature sensor for sensing the temperature of the heated component.

The sensor arrangement may include a light curtain assembly arranged on the apparatus to sense the ingress of a foreign object into the operational zone.

The sensor arrangement may include a pressure sensor to sense the fluid pressure of the actuators.

The sensor arrangement may include a base assembly sensor to sense the presence of the base assembly.

The sensor arrangement may include a barcode scanner to scan a barcode of the base assembly to verify the authenticity thereof.

The sensor arrangement may include an integrated circuit carrier film sensor to sense the presence of the integrated circuit carrier film.

The sensor arrangement may include an alignment sensor to sense an alignment of the integrated circuit carrier film relative to the support.

The sensor arrangement may include an electricity sensor to monitor the electrical power supply.

According to a fourth aspect of the invention there is provided a bonding apparatus for bonding a carrier sheet used for carrying printhead integrated circuits to be tested to a carrier base, said apparatus comprising:

a support assembly configured to receive and support the carrier base;

a lamination head arranged on the support assembly and configured to bond the carrier sheet to the carrier base;

a conformal material supply mechanism arranged on the support assembly and configured to interpose a conformal material between the surface and the head prior to bonding; and

a controller to control operation of the lamination head and the supply mechanism to facilitate bonding of the carrier sheet to the carrier base.

The head may include a heated platen configured to bear against the carrier sheet for thermally bonding the carrier sheet to the carrier base.

The head may include a temperature sensor to sense a temperature of the heated platen, the temperature sensor being connected to the controller to control a temperature of the heated platen.

The head may include a pressure sensor to sense a pressure which the heated platen applies during bonding, the temperature sensor being connected to the controller to control a pressure applied by the heated platen.

The conformal material supply mechanism may include a feed reel and a take-up reel respectively located on opposite sides of the lamination head, to feed the conformal material across the heated platen.

The conformal material supply mechanism may include an incremental sensor to sense a length of the material fed across the heated platen.

According to a fifth aspect of the invention there is provided an alignment mechanism for aligning a lamination film with a carrier substructure prior to laminating the film to the substructure to form a test carrier for integrated circuits, the substructure and the lamination film defining complementary perforations and a plurality of respective fiducials, said alignment mechanism comprising:

a sensor arrangement configured to detect the fiducials in the lamination film and substructure;

a displacement mechanism configured to displace the lamination film with respect to the substructure to align the perforations of the film and substructure respectively according to alignment of their fiducials so that a printing fluid can pass through the perforations in the film and the substructure of the test carrier; and

a controller configured to control operation of the sensor arrangement and the displacement mechanism.

The displacement mechanism may include actuators configured to displace the substructure relative to the lamination film along at least two axes.

The actuators may be in the form of a number of linear actuators that operatively engage the substructure to displace it along one axis and a number of linear actuators that operatively engage the lamination film to displace it along an orthogonal axis.

The sensor arrangement may include a digital camera and lens arrangement in signal communication with the controller for identifying the fiducials.

The digital camera and lens arrangement may be configured to identify fiducials in the form of complementary openings defined in the substructure and the lamination film.

The alignment mechanism may include an operator interface operatively connected to the controller and configured to receive displacement instructions from an operator.

The displacement mechanism may be configured to displace the lamination film incrementally relative to the carrier or lamina, respectively.

According to a sixth aspect of the invention there is provided a software product for execution by a controller of a laminating apparatus, as described above, said software product enabling the apparatus to perform a method having the steps of:

receiving the carrier in a cradle platform;

aligning each said fiducial with respective fiducials in a lamina having a series of such holes therein; and

bonding the aligned lamina to the carrier, so that a printing fluid is able to pass through the laminated apertures after such bonding.

According to a seventh aspect of the invention there is provided a computer readable memory incorporating a software product, as described above.

Embodiments of the invention are now described, by way of example, with reference to the accompanying drawings. The following description is intended to illustrate particular embodiments of the invention and to permit a person skilled in the art to put those embodiments of the invention into effect. Accordingly, the following description is not intended to limit the scope of the preceding paragraphs in any way.

### BRIEF DESCRIPTION OF THE DRAWINGS

In the accompanying drawings:

FIG. 1 shows a perspective view of an embodiment of a carrier without lamination film to which a lamination film is to be bonded with a laminating apparatus in accordance with one embodiment of the invention.

FIG. 2 shows a perspective view of the embodiment of the carrier of FIG. 1 with the lamination film bonded thereto, in accordance with one embodiment of the invention.

FIG. 3 shows a front perspective view of one embodiment of a laminating apparatus, in accordance with the invention.

FIG. 4 shows an operator interface of the apparatus of FIG. 3.

FIG. 5 shows an operator display panel of the apparatus of FIG. 3.

FIG. 6 shows a closer view of an alignment mechanism, in accordance with one embodiment of the invention, of the apparatus of FIG. 3.

FIG. 7 shows a perspective view of lamination support or cradle platform, in accordance with one embodiment of the invention, for operatively receiving the carrier of FIG. 1.

FIG. 8 shows a closer perspective view of the lamina supply of the alignment mechanism of FIG. 6.

FIG. 9 shows a side schematic view of the lamina supply of FIG. 8.

FIG. 10 shows an embodiment of an optical assembly of the alignment mechanism of FIG. 6.

FIG. 11 shows a closer perspective view of the bonding apparatus of FIG. 6.

FIG. 12 shows a side perspective view of the bonding apparatus of FIG. 6.

FIG. 13 shows a detail view of the bonding apparatus of FIGS. 11 and 12.

FIG. 14 shows a top diagrammatic view of the apparatus of FIG. 6, showing respective axial orientations of motors for the alignment mechanism of FIG. 6.

FIGS. 15A and 15B show an example of an alignment process displayed by the operator display panel.

FIG. 16 shows a front view of an open service enclosure of the apparatus of FIG. 3.

FIG. 17 shows a rear view of an open service enclosure of the apparatus of FIG. 3.

FIG. 18 shows an inner schematic view of a lower rear open service enclosure of the apparatus of FIG. 3.

FIG. 19 shows an outside view of the service enclosure of FIG. 17.

FIG. 20 shows a close-up view of a cutting assembly of the apparatus of FIG. 1.

FIG. 21 shows a block diagram representing a method of laminating the carrier, in accordance with one embodiment of the invention, with the apparatus shown in FIG. 3.

FIG. 22 shows a functional block diagram of a laminating process performed by the apparatus of FIG. 3.

FIG. 23 shows a control layout of a safety system, in accordance with one embodiment of the invention, of the apparatus shown in FIG. 3.

FIG. 24 shows a programmed logic controller (PLC) layout of the apparatus shown in FIG. 3.

FIG. 25 shows a control layout of a heater cylinder, a positioning cylinder, ultrasonic knife cylinders and carrier and film or tape grippers of the apparatus of FIG. 3.

FIG. 26 shows a network control layout of the apparatus of FIG. 3.

FIG. 27 shows a power layout for ultrasonic knives of the apparatus of FIG. 3.

FIG. 28 shows a control layout of a first motor or actuator of the apparatus of FIG. 3.

FIG. 29 shows a control layout of a second motor or actuator of the apparatus of FIG. 3.

FIG. 30 shows a control layout of a third motor or actuator of the apparatus of FIG. 3.

FIG. 31 shows a control layout of a fourth motor or actuator of the apparatus of FIG. 3.

FIG. 32 shows a control layout of a fifth motor or actuator of the apparatus of FIG. 3.

FIG. 33 shows a control layout of a sixth motor or actuator of the apparatus of FIG. 3.

FIG. 34 shows a control layout of a seventh motor or actuator of the apparatus of FIG. 3.

FIG. 35 shows a control layout of a film liner take-up motor of the apparatus of FIG. 3.

FIG. 36 shows a control layout of a heater tape feed motor of the apparatus of FIG. 3.

FIG. 37 shows a control layout of a heater tape tension motor of the apparatus of FIG. 3.

FIG. 38 shows a control layout of a heater tape encoder motor of the apparatus of FIG. 3.

### DETAILED DESCRIPTION

Aspects of the invention will now be described with reference to specific embodiments thereof. Reference to “an embodiment” or “one embodiment” is made in an inclusive rather than a restrictive sense. As such, reference to particular features found in one embodiment does not exclude those features from other embodiments.

### Carrier Overview

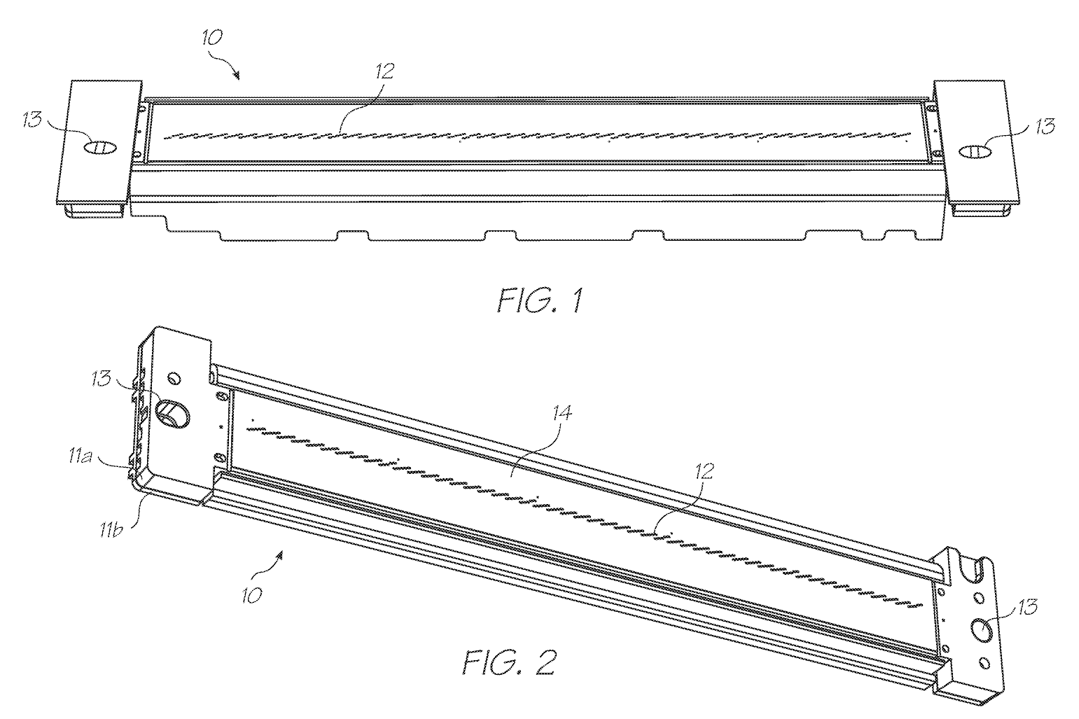

In broad aspects, the invention relates to bonding a lamina film to a carrier 10, an example of which is shown in FIG. 1. The carrier 10 is generally an assembly of two liquid crystal polymer (LCP) micro-moldings 11a and 11b. The micro-moldings 11 define a plurality of discrete tortuous ink paths for ducting ink from an ink reservoir (not shown) to a printhead integrated circuit (not shown).

Accordingly, the carrier 10 is used to test the operation of such printhead integrated circuits (IC) prior to assembling such an IC into a printer or printing equipment. Given the operation of these printhead IC's, it is generally necessary to establish a seal between the tortuous ink paths defined in the carrier 10 and fluid inlets of the IC. For this reason, the Inventor has found that by laminating the carrier 10 with a lamina film 14, such a fluid tight seal can be established between the carrier 10 and IC when the IC is fastened to the carrier 10. This helps to ensure that ink is supplied to the printhead ICs in a leak-free manner.

The ink paths through the carrier 10 typically terminate as fiducial apertures or “fiducials” 12 in a surface of the carrier 10, shown in FIG. 1. It is therefore necessary to bond the lamina 14 to the carrier 10 without blocking or impeding these fiducials, otherwise ink will be prevented from flowing through the carrier 10 to the printhead ICs. An example of a carrier 10 having the lamina 14 applied is shown in FIG. 2. It is clearly shown that the fiducials 12 are not blocked to ensure proper ink supply.

The carrier 10 also defines two locating openings 13 at respective opposite ends, as shown. The purpose of the locating openings 13 is to fix and align the carrier accurately prior to the laminating process. Details of such laminating are made clear in the following description.

### Apparatus Overview

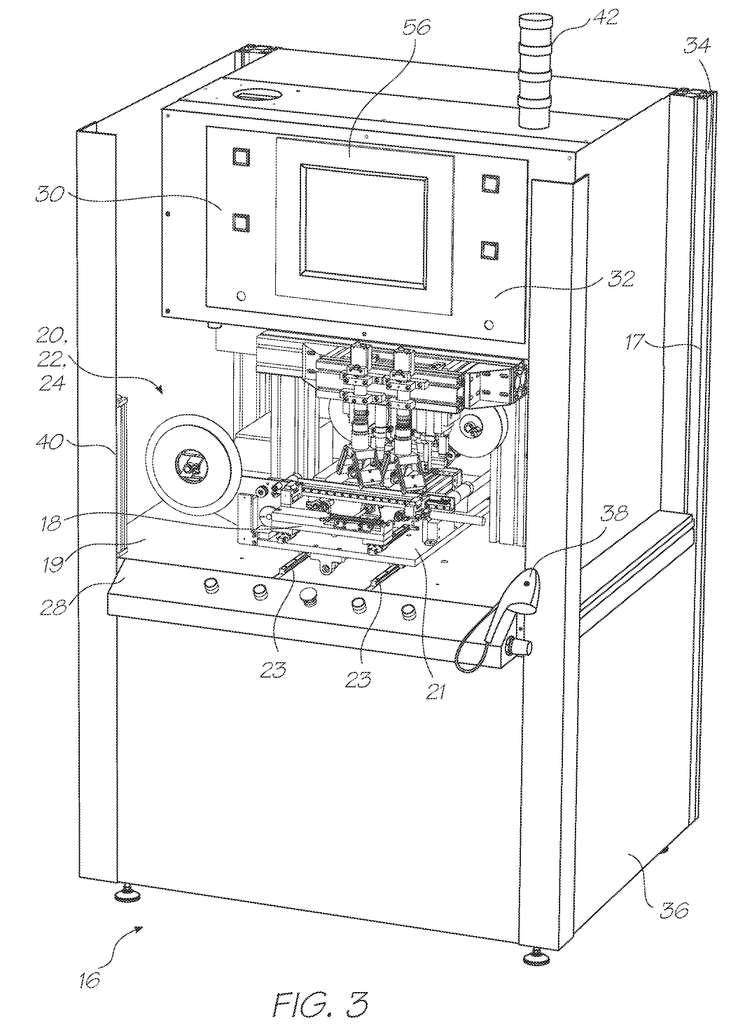

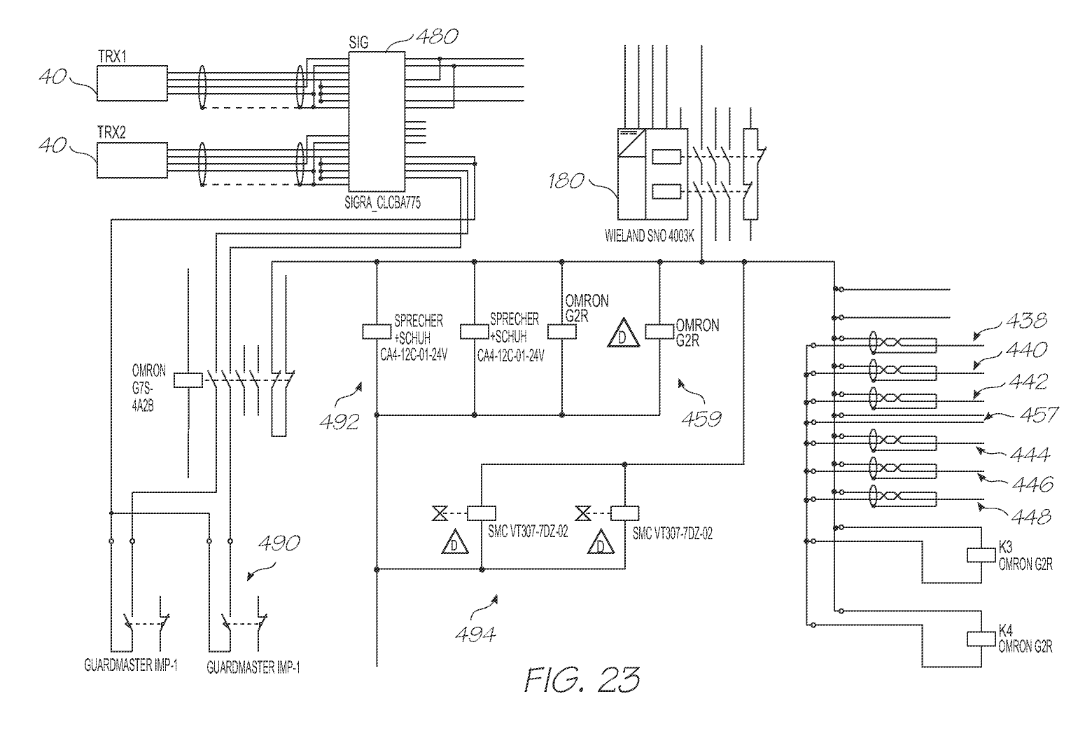

FIG. 3 shows one embodiment of an apparatus 16 for accurately aligning the fiducials 12 with corresponding apertures in the lamina film 14. The apparatus 16 can also bond the lamina 14 to the carrier 10 once proper alignment has been achieved. The apparatus 16 includes, inter alia, a support structure 17 defining an enclosure which houses a laminating support or cradle platform 18, as well as a lamina supply 20, an alignment mechanism 22, bonding apparatus 24, and a controller or control system 26 (described below with reference to control layout FIGS. 23 to 38) operatively controlling these components. These components are positioned on a floor portion 19 of the apparatus 16, as shown. Also included is an operator control panel 28 and an operator display panel 30 enabling an operator to regulate and manage the operation of the controller 26, and hence the apparatus 16.

The apparatus 16 also includes a safety system 31, typically implemented via the controller 26, described in more detail below with reference to FIG. 23. One feature of the safety system is a light curtain 40 and a warning beacon 42, shown in FIG. 3. The beacon 42 includes a stack light display, with different coloured lights indicating different operational states of the apparatus 16. The enclosure has a number of service panels covering control components housed in the enclosure, namely a front equipment enclosure 32, a rear equipment enclosure 34, and a lower rear equipment enclosure 36. These components are discussed in more detail below.

The apparatus 16 also has a barcode scanner 38, which is used to scan a barcode of the carrier 10. The controller 26 is typically arranged in signal communication with a remote monitoring system or RMS (not shown). This remote monitoring system can be connected to a number of semi-autonomous apparatus, machines or devices involved in the assembly, manufacture or testing of the carrier 10 and/or other equipment involving the carrier 10 or IC's. The remote monitoring system is able to keep track of all the carriers assembled in this manner, which allows quality and assurance control of such an assembly process.

For example, if each device forming part of such an assembly process scans and uploads a barcode of the carrier 10, or of parts forming the carrier 10, then the remote monitoring system can prevent further assembly of a carrier or parts which are not standard or are inferior. In the case of the apparatus 16, if the carrier 10 is successfully laminated, as described below, then the remote monitoring system will log the barcode of the successfully laminated carrier 10 to allow further devices, such as an IC attaching machine, to further process the carrier 10. Similarly, if the apparatus 16 fails to laminate the carrier 10 successfully, the remote monitoring system can log the barcode of the particular carrier as inferior to prevent further machines from processing such a sub-standard carrier.

### Operator Control Panel

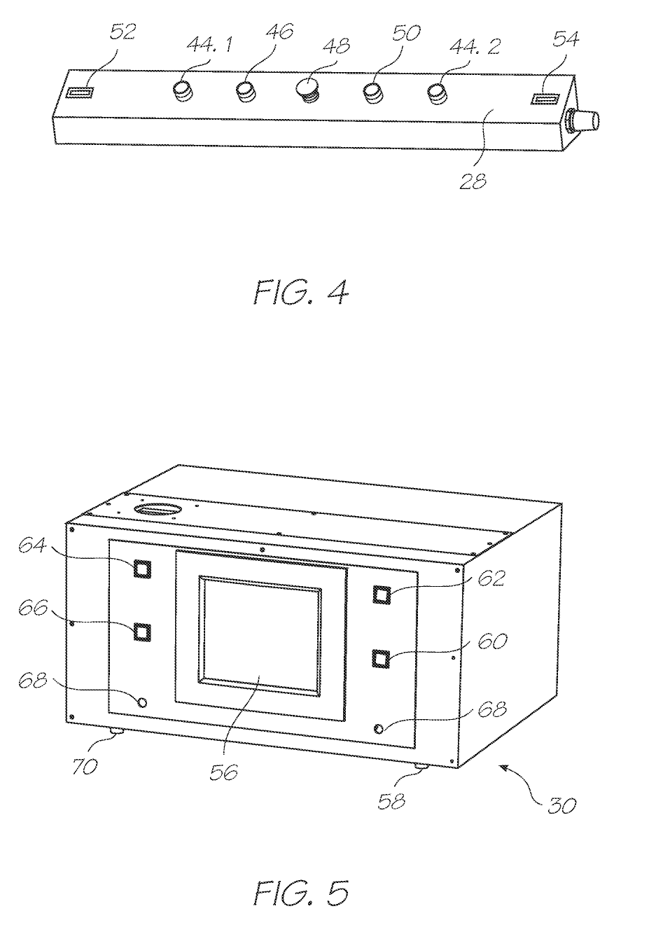

The operator control panel is shown in FIG. 4. In the embodiment shown, the control panel 28 includes two start buttons 44.1 and 44.2. These start buttons 44 are spaced apart to prevent accidental activation of the apparatus 16. The start buttons 44 also ensure that both arms of the operator are kept away from moving components of the apparatus 16 when the apparatus 16 is initiated. Thus, an operator must generally deliberately press both buttons 44 simultaneously to start the apparatus 16. The panel also includes a reset button 50 to reset the apparatus to an idle state, and a scan button 46 which activates the barcode scanner 38. An emergency stop button 48 instructs the controller 26 to halt all operation of the apparatus 26. As such, it is to be appreciated that the buttons are all linked to the controller 26, which is responsible for the operation of the apparatus 16, as will be described below.

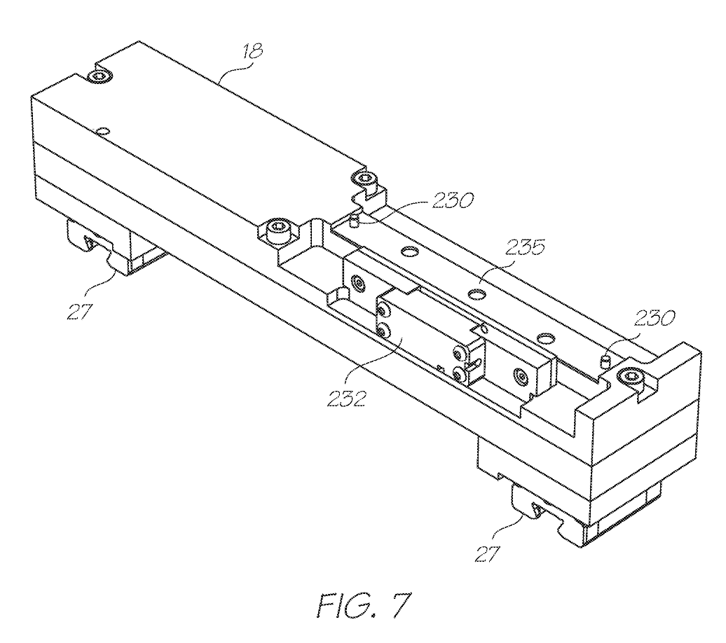

The lamination process is a semi-automated process under control of the controller or control system 26. The operator generally manages the operation of the controller 26 via the operator control and display panels 28 and 30. The operator is generally tasked with inserting the carrier 10 into a nest formation 235 (FIG. 7) on the support platform 18 of the apparatus 16, and removing the carrier 10 once the lamina 14 has been applied to said carrier 10. General maintenance and overseeing, such as monitoring of a lamina supply, correct alignment, etc. are the responsibility of the operator.

The reset, start and scan buttons 50, 46 and 44, respectively, are flush, momentarily illuminated, coloured lens push buttons having normally open switches. The emergency stop button 48 is a 40 mm, twist and pull to release, non-keyed heavy duty operating button with a normally closed switch. The Inventor has found buttons manufactured by Sprecher and Schuh to be suitable.

The operator interface panel 28 also includes a pressure regulator 52 for an ultrasonic knife assembly 86 and a platen pressure regulator 54 for the bonding apparatus 24, described in more detail below. The apparatus 16 includes electrically as well as pneumatically actuated components to effect movement of the relevant components. The regulators 52 and 54 allow the operator to monitor pneumatic pressure in such pneumatically actuated components.

### Display Panel

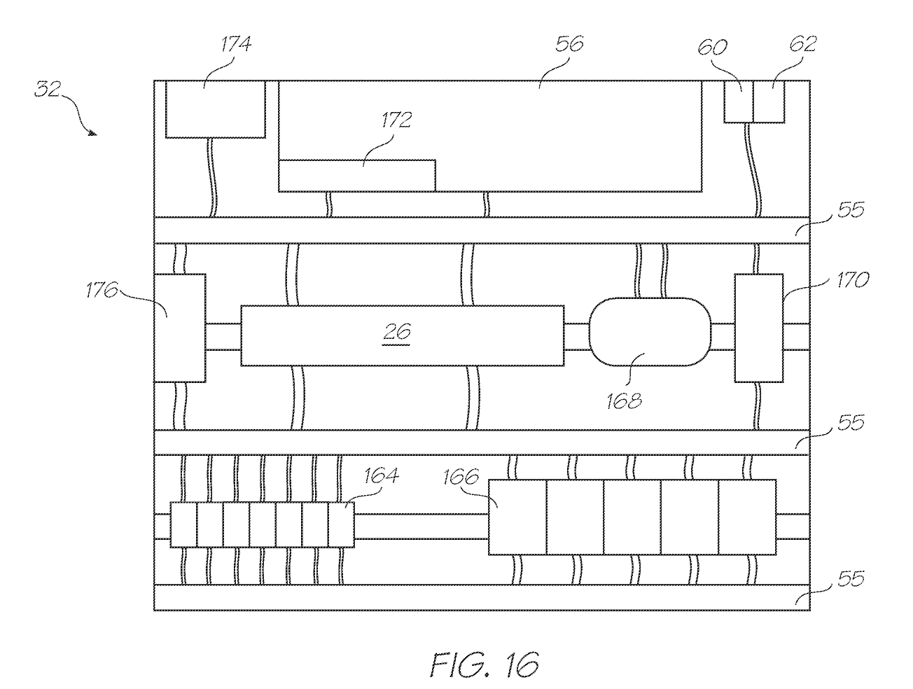

The apparatus 16 also includes the display panel 30, shown in FIG. 5, via which the operator is shown an operational status of the apparatus 16. In the embodiment shown, the panel 30 includes a computer with integrated flat panel display 56 along with a number of sensor indicators. The sensors on the panel 30 include a pressure sensor of the bonding mechanism 24, a main system pressure sensor 62, a pressure sensor for a clamp 64 clamping the carrier 10 to the cradle platform 18, and a pressure sensor for the knife assembly 86. There are also pressure regulators on the panel 30, namely a pressure regulator 70 for the clamps of the cradle assembly 18, and a main system pressure regulator 58 for a pneumatic system of the apparatus 16. The panel 30 also includes locking handles 68 for opening the panel 30 to reveal the inner enclosure shown in FIG. 16, described below.

In the embodiment shown, the pressure sensors 60, 62, 64 and 66 are SMC ISE40 digital pressure sensors to provide readouts for the different portions of a pneumatic system of the apparatus 16. The pressure regulators 58 and 70 are SMC AR29K-02H pressure regulators. The touch panel with computer is an Advantech® resistive analog touch screen with an integrated PC with a Pentium® IV processor.

### Alignment and Laminating Arrangement

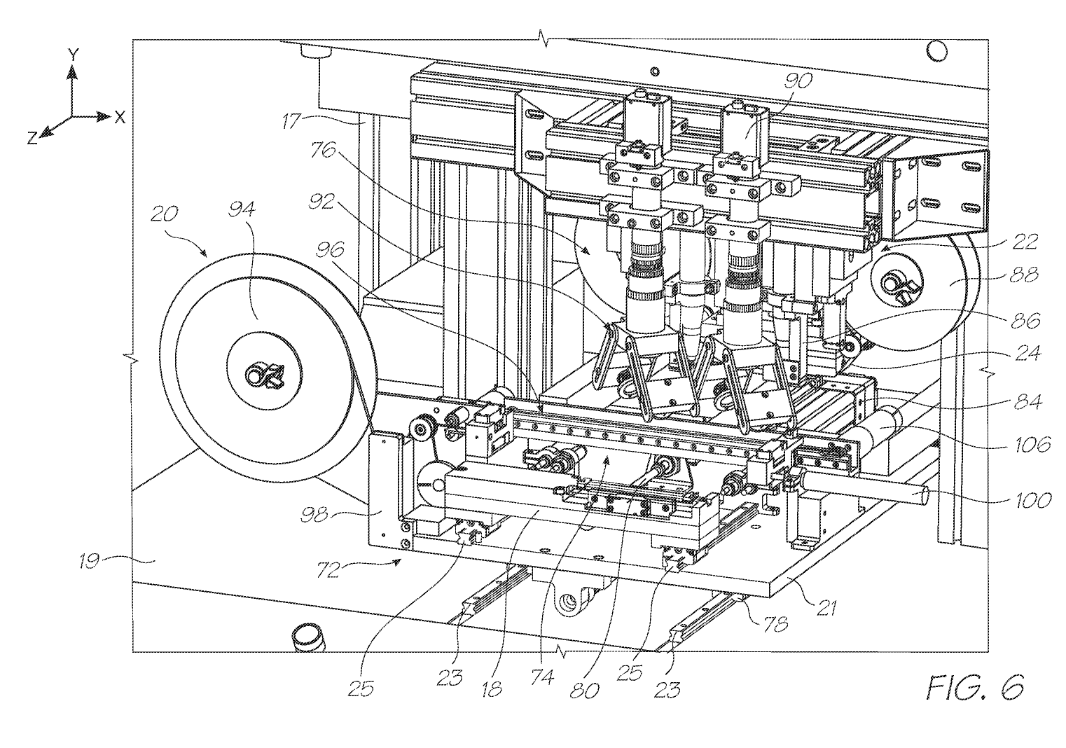

The lamination support or cradle platform 18, lamina supply 20, alignment mechanism 22, and bonding apparatus 24 are shown in more detail together in FIG. 6. These components 20, 22 and 24 together constitute an alignment and laminating arrangement. The individual components are described in more detail below.

As mentioned above, the apparatus 16 includes the support structure 17 with a floor 19 mounted in said support structure 17 to define a planar support surface or floor 19. As shown, the table 21 is mounted on the floor 19 via a pair of spaced support rails 23 to form a table assembly 72. A table actuator 84 is fast with the floor 19 and connected to the table 21 to displace the table 21 along the rails 23 in a Z-axis direction, under control of the control system 26. A pair of Z-axis guide rails 25 is also mounted on the table 21. By having the table 21 mounted on the floor 19 in such a manner, the table assembly 72 can slide in and out of the apparatus 16 to allow an operator easier access when loading or unloading the carrier 10 into the cradle platform 18 of the apparatus 16. The guide rails 25, in turn, enable the controller 26 to align the fiducials of the carrier with the apertures in the lamina film 14. The different components of the laminating arrangement will now be described.

### Lamination Support

The lamination support, stage or cradle 18 is mounted on the table 21 and is shown in more detail in FIG. 7. The stage 18 has a pair of spaced guide feet 27 in which respective guide rails 25 of table 21 can be slid. A pneumatic linear stage actuator 80 is fast with the table 21 and is connected to the stage 18 to displace the stage 18 along the Z-axis, under control of the control system 26.

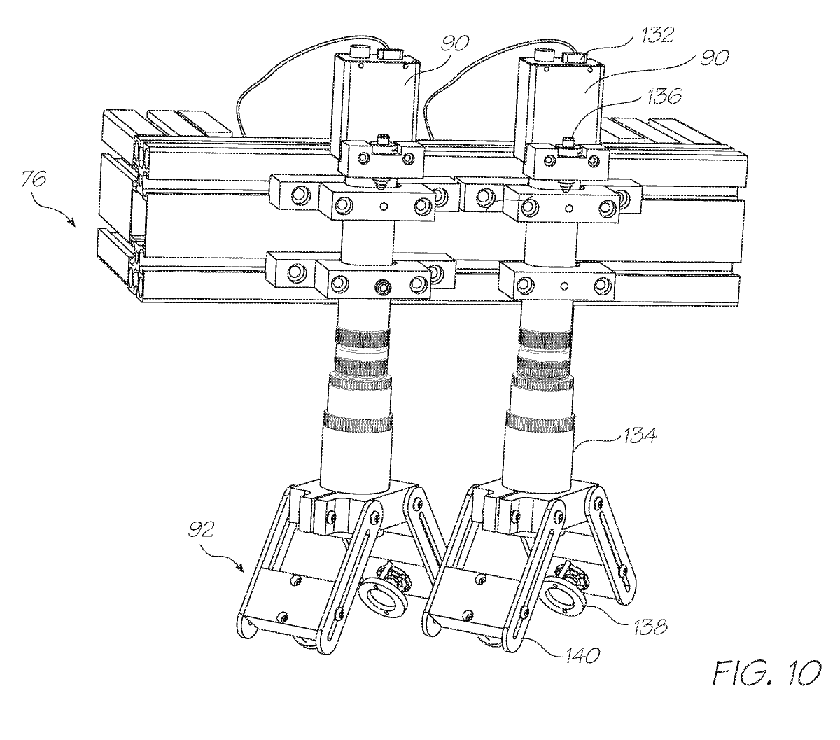

The stage 18 can be moved by the control system 26 along the guide rails 25 for aligning the lamina 14 with the carrier 10 under a camera arrangement 76 (FIG. 10). The actuator 80 enables fine and precise movements of the carrier 10 to facilitate the alignment of the microscopic fiducials of the carrier 10 with the apertures in the lamina 14.

The stage 18 defines a nest formation 235 in which the carrier 10 is received, in use. A pair of spaced locating pins 230 extends from the stage 18, in the formation 235, to be received in the locating openings 13 defined in the carrier 10. A manually adjustable stop member 232 is also positioned on the stage 18 to ensure that the carrier 10 is correctly aligned when the pins 230 are received through the openings 13.

### Lamina Supply

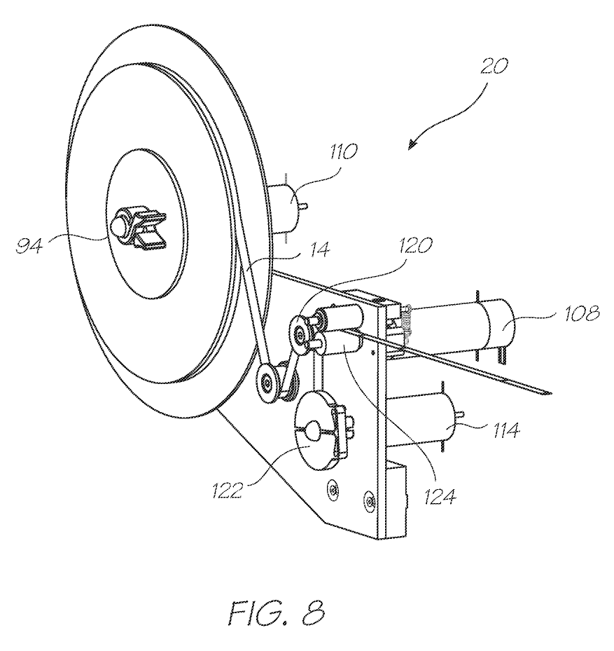

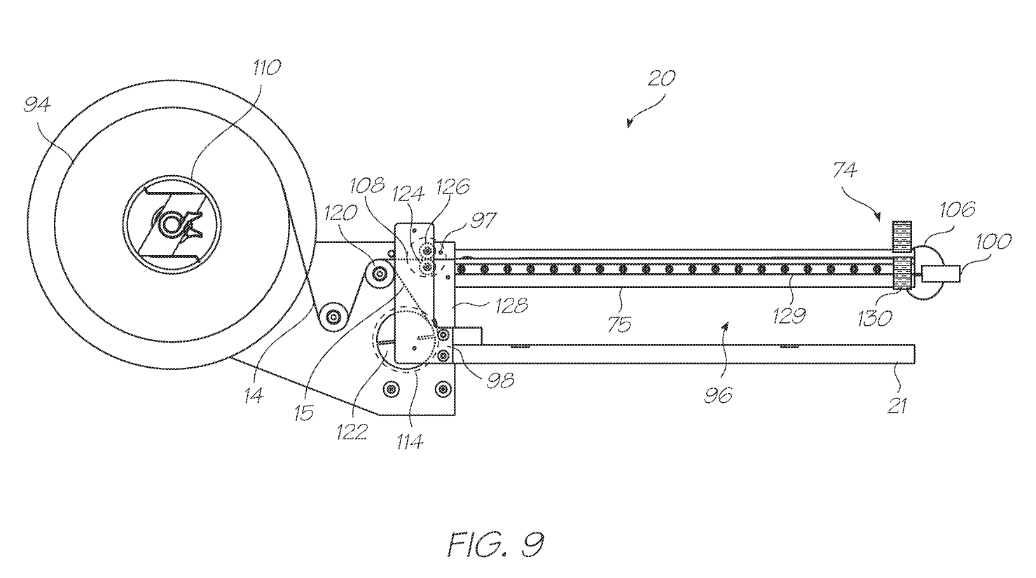

The lamina supply 20 is shown in more detail in FIGS. 8 and 9. Broadly, the lamina supply 20 provides the lamina film 14 for bonding to the carrier 10, in use. The alignment mechanism 22 (described below) aligns the supplied lamina 14 over the carrier 10, so that the fiducials 12 line up with corresponding apertures in the lamina. 14. Once aligned, the bonding apparatus 24 bonds the lamina 14 to the carrier 10. The stage 18 mounted to the table 21 is moved with the table assembly actuator 84, under control of the control system 26, below the bonding apparatus 24 for the bonding process.

The lamina supply 20 features a lamination film reel 94, a film gripper assembly 96, and an ionizer bar 98. The lamina supply 20 also includes a removal roller 120, and a liner take-up spool 122. In one embodiment, the lamina film 14 is approximately 11 mm wide and consists of a 50 μm polyimide carrier with 25 μm of adhesive on both sides thereof. The film 14 also has a 12.7 μm PET liner 15 on the side of the carrier 10, which liner 15 is removed at the removal roller 120 prior to lamination. The liner 15 is wound up on take-up spool 122 for later disposal. A cleaning roller 124 removes loose particles from the film, and an ionizer bar 98 reduces a static charge which may be present on the lamina film 14 due to the removal of the liner 15, to prevent attracting further loose particles. A pinch roller 126, which drives the cleaning roller 124, and a static film gripper 128 facilitate feeding of the lamina film 14 to a film gripper 130. The film gripper 130 operatively feeds the lamina film over the platform 18 with the carrier 10 positioned thereon.

In use, drives, actuators or motors 110 and 108 drive the lamina 14 to the film gripper assembly 96, under control of the control system 26. Similarly, the liner 15 is wound up on take-up spool 122 by drive 114, under control of the control system 26. The static film gripper 128 includes a tape sensor 97 which is monitored by the control system 26. The lamina 14 is fed through the static film gripper 128 by drive 108 and pinch roller 126, as shown. Once a sufficient length of film has been fed to the film gripper 130, the film gripper 130 is actuated by control system 26 to grip this length of lamina. A film gripper drive mechanism 74 includes a gripper rail 75 on which the film gripper 130 runs. The film gripper 130 is driven along the rail 75 by means of a drive belt 129 actuated by an actuator or motor 106 under control of the control system 26.

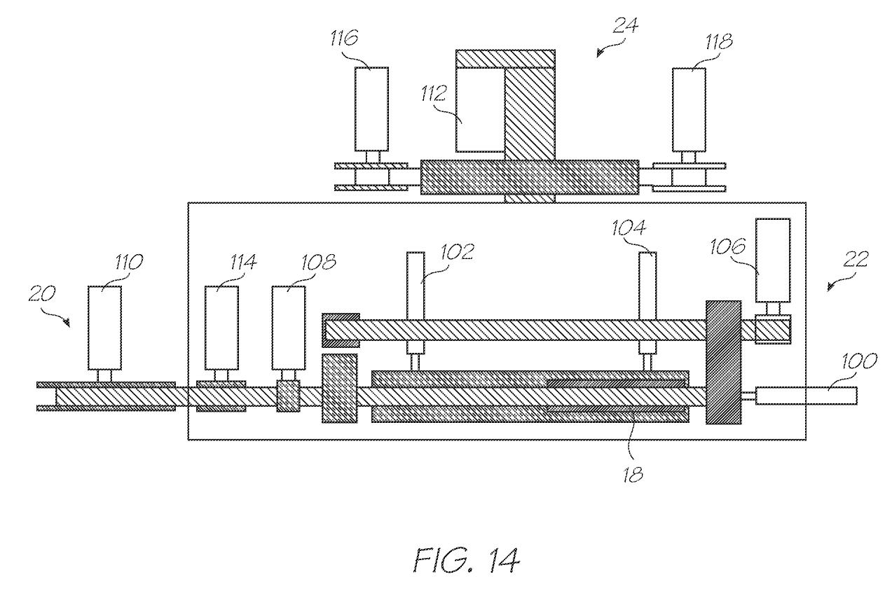

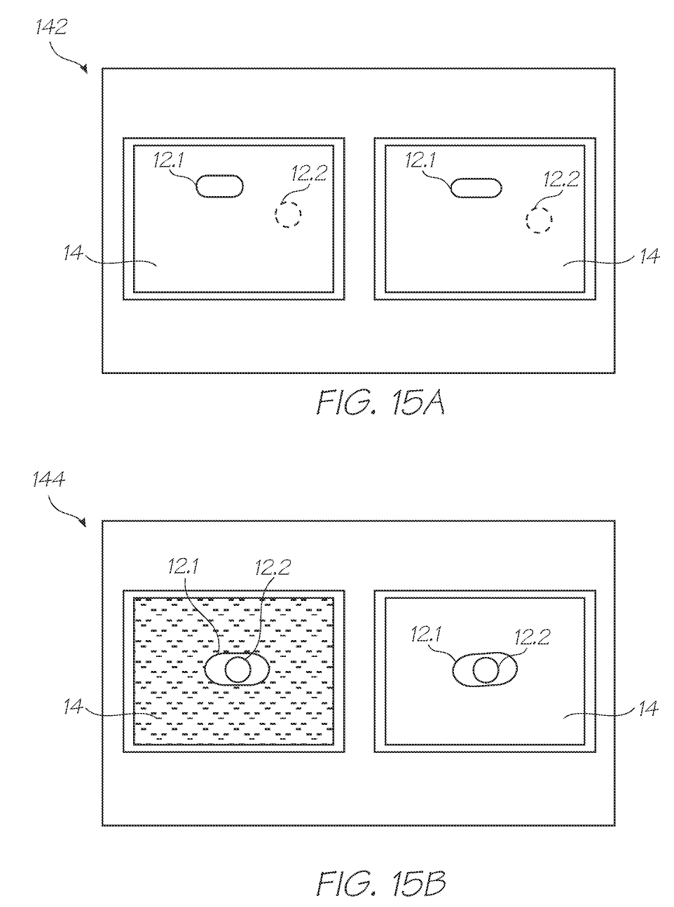

The film gripper 130 grips the lamina film supplied from the spool or lamination film reel 94 and pulls it though the static film gripper 128 when the drive belt 129 is actuated by the actuator 100. When a sufficient amount of film has been pulled across the cradle 18, (as determined by gripper position sensors on the rail 75) under control of the control system 26, the gripper 130 stops and the static film gripper 128 grips the film so that the lamina is securely held by both grippers 128 and 130. The film pulled across the carrier 10 in the cradle 18 is then aligned by means of the camera arrangement 76 and actuators 102, 104 and 100 (FIG. 14), described in more detail below.

### Camera Arrangement

Referring now to FIG. 10, the camera arrangement 76 includes cameras 90 arranged in signal communication with the controller or control system 26 by means of Firewire connectors 132. The camera arrangement 76 also includes telecentric lenses 134 for focusing the cameras 90. Also included are LED assemblies 92, having LEDs 138 supported on LED support frames 140, for illuminating the film 14 and carrier 10 for examination by the controller 26 via cameras 132. The arrangement 76 also features focal adjustment screws 136 whereby a focal point of the cameras 132 can be manually adjusted.

The Inventor has found that AVT F-131B cameras, which are IEEE1394 SXGA C-mount cameras having a highly sensitive CMOS sensor, are suitable for the application. In addition, the LEDs 138 are red, star, 1 Watt Lumileds with a 625 nm wavelength and controlled by a Gardasoft® PP610 lighting controller to provide repeatable intensity control of the LED lighting for fiducial protection. It is to be appreciated that the lighting controller forms a part of the global control system of the laminating apparatus 16, described below.

In use, the control system 26 controls the linear stage actuator 80 (FIG. 6) to move the cradle 18 with carrier 10 around under the camera arrangement 76. This is after the table assembly actuator 84 has moved the table 21 into the apparatus 16. The cameras 90 allow the control system to “see” when the fiducials and apertures align.

### Bonding Apparatus

The bonding apparatus 24 is shown in more detail in FIGS. 11 to 13. The bonding apparatus 24 is controlled by the controller 26 to provide the required pressure and heat to bond the film 14 to the carrier 10 after alignment of the fiducials and apertures. The bonding apparatus 24 includes a heated lamination head 146 actuated by actuator cylinder 154. Also included is a conformal tape dispensing assembly consisting of a tape feed reel 88 and tape take-up reel 148 with respective reel actuators 118 and 116. The reels 88 and 148 dispense a conformal tape 152 over the head 146 to facilitate even distribution of heat and pressure. The apparatus 24 includes an incremental tape sensor 150 to measure the amount of tape 152 dispensed over the head 146. The Inventor has found that Fujipoly® SARCON black 850 μm tape is suitable for the application.

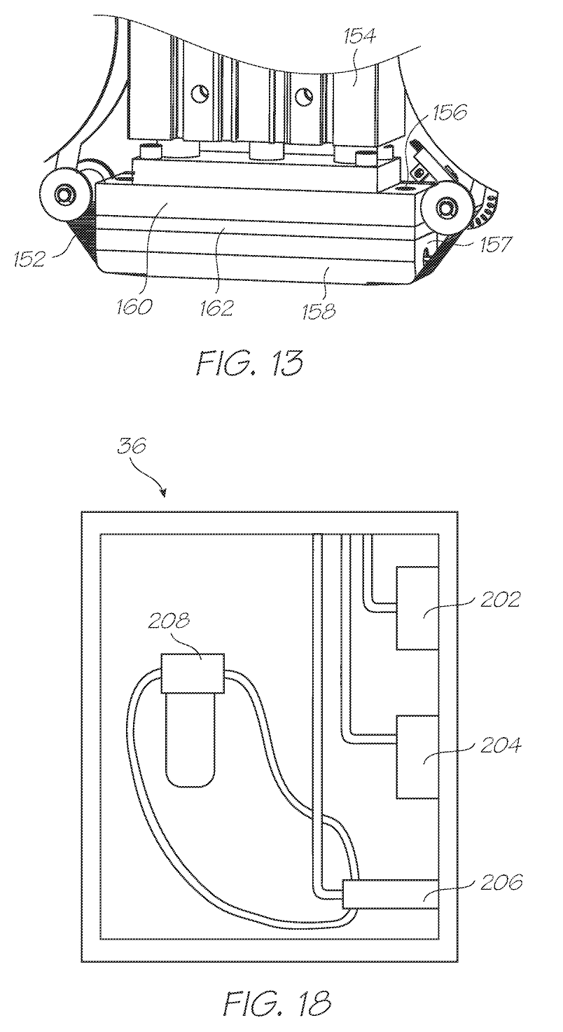

The lamination head 146 is shown in more detail in FIG. 13. The head 146 generally features a plate support 160 to support an insulation sheet 162, a heater cartridge 157 and a lamination plate 158, as shown. The sheet 162, cartridge 157 and plate 158 are attached to the support plate 160 via retaining screws 156.

Once the lamina film 14 has been aligned with the carrier 10, the table actuator 84 moves the table 21 to the bonding apparatus 24. The bonding apparatus 24 then lowers the lamination head 146 with pneumatic actuator 154 to apply heat and pressure to bond the film to the carrier 10. Actuator 154 is a pneumatic actuator piston and cylinder arrangement in the form of an SMC compact guide cylinder to achieve the necessary pressure.

### Alignment Mechanism

The alignment mechanism, broadly indicated by reference numerals 20, 22, 24 in FIGS. 3 and 6 (components separately described above), is responsible for aligning the film 14 fed over the platform 18 with the carrier 10. It is to be appreciated that the controller 26 typically automates the alignment process. To this end, the alignment mechanism 22 includes the camera arrangement 76 of FIG. 10. The camera arrangement 76 enables the controller 26 to examine the film 14 and carrier 10 and to actuate the cradle platform 18 to align the fiducials with corresponding holes in the film.

FIG. 14 shows a top diagrammatic view of the different actuators required by the lamina supply 20, the lamination support and the bonding apparatus 24 which together constitute the alignment mechanism. The indicated actuators are typically electrical actuators under control of the controller 26. The controller 26 is configured to control the operation of the respective actuators in response to feedback from a number of sensors, such as the camera arrangement 76. Actuator 100 is used to control the final position of the lamination film 14 in relation to the carrier 10. Actuators 102 and 104 are responsible for displacing the cradle platform or lamination support 18 in a plane coplanar with the representation of FIG. 7. The Inventor has found that the Ealing EncoderDriver™ actuator package 37-9685 is suitable for actuators 100, 102, and 104. These actuators include an integral DC motor, gearhead, micrometer precision leadscrew and magnetic encoder which provides full sub-micrometer control of said platform 18 to the controller 26.

The actuator 106 is responsible for moving the lamination film gripper 130 with the drivebelt 129. The gripper assembly 96 picks up the lamination film from the lamina supply film reel 94 and feeds it across the platform 18, as described above. The actuators 100, 102, and 104 provide final and accurate positioning of the film 14 and carrier 10.

The actuator 108 drives a lamination tape cleaning roller 120 (FIG. 8). The actuator 110 drives the lamination film feed reel 94 and actuator 114 drives a lamination liner take-up spool 122. The actuators 116 and 118 are responsible for feed and take-up, respectively, of the conformal tape 152 across the lamination head 146 (FIG. 11) of the bonding apparatus 24. The actuator 112 is an electric cylinder and motor to move the table assembly 72 into position for bonding the lamina with the bonding apparatus 24. The Inventor has found the Maxon® RE30 series of motors suitable for actuators 106, 108, 110, 114, 116, and 118. The Inventor has found the Parker® ETB32-B08P series actuator suitable for actuator 112.

Circuit diagrams of the above actuators and linear encoders are discussed in more detail below with reference to FIGS. 23 to 38.

### Lamina Alignment

An example of an output shown on the PC with display panel 56 is shown in more detail in FIG. 15. The display provides the operator with a view of the alignment process performed by the controller 26, and generally includes a view of the carrier 10 and film 14 taken by the camera arrangement 76, described above. Reference numeral 142 in FIG. 15A indicates a view displayed on the PC panel 56 while the fiducials 12 are not yet aligned, whilst reference numeral 144 in FIG. 15B shows a view of fiducials 12.2 aligned with the corresponding holes 12.1 in the film 14.

It is to be appreciated that the alignment process is under control of the control system 26. However, in one embodiment of the invention, the controller 26 allows the operator to attempt manual alignment should the controller 26 be unable to align the fiducials 12.1 and the holes 12.2 successfully. In such a case, the controller 26 will provide the operator with an override control of the alignment process, typically via buttons on the touch screen display 54, or the like. This may occur where the control system 26 is unsuccessful in detecting the fiducials.

### Control System

Referring now to FIGS. 16 to 19, the components of the controller or control system 26 of the laminating apparatus 16 are now discussed in further detail. It is to be appreciated that the controller 26 comprises a number of separate components and sensors in order to fulfill all the functions and tasks required from the controller 26. In addition, the laminating apparatus 16 includes a safety system which is typically defined by means of the different sensors and operating instructions performed by the control system.

FIG. 16 shows the panel 30 of FIG. 3 in an open position so that internal components of the control system are visible. The flat panel PC 56 is shown, along with pressure sensors 60 and 62. Also visible is a programmable logic controller (PLC) block 26, which forms a functional element of the safety and control system. The PLC 400 is connected to the PC 56 at 402 to receive its program from the PC 56.

The PLC 26 is modular as shown in the rail mounting positions diagram 404. The PLC 402 includes a main controller block 414, a Controller Area Network (CAN) serial bus block 408, a 12-bit, 4 channel analogue output block 410, a temperature control block 412, a 2 or 4 input module 406 and an Ethernet interface block 416.

The modular PLC block effectively represents controller 26. As will be appreciated by a skilled person, the PLC 26 is responsible for the overall control and management of the apparatus 16. Some of the components controlled by the PLC 26 include the cradle platform 18 with related actuators, the lamina supply 20, the bonding apparatus 24, the alignment mechanism 22, and the barcode scanner 38.

The internal components visible in FIG. 16 are generally connected by means of trunking 55, which houses the necessary connectors, electrical wires and pneumatic lines to establish the required connection between the components.

The PLC 26 typically includes a number of different modules each responsible for different aspects. For example, analog and network communication blocks may be used to interact with different pneumatic sensors and to interface the PLC 26 with the remote monitoring system. The Inventor has found the Mitsubishi® FX3U-48MR PLC suitable as controller 26, along with a FX2N-2LC temperature control block, a FX2N-4AD analog input module, a FX2N-4DA analog output module, a FX3U-ENET Ethernet interface module, and a FX2N-32CAN controller area network serial bus block. These modules collectively represent the PLC block 26.

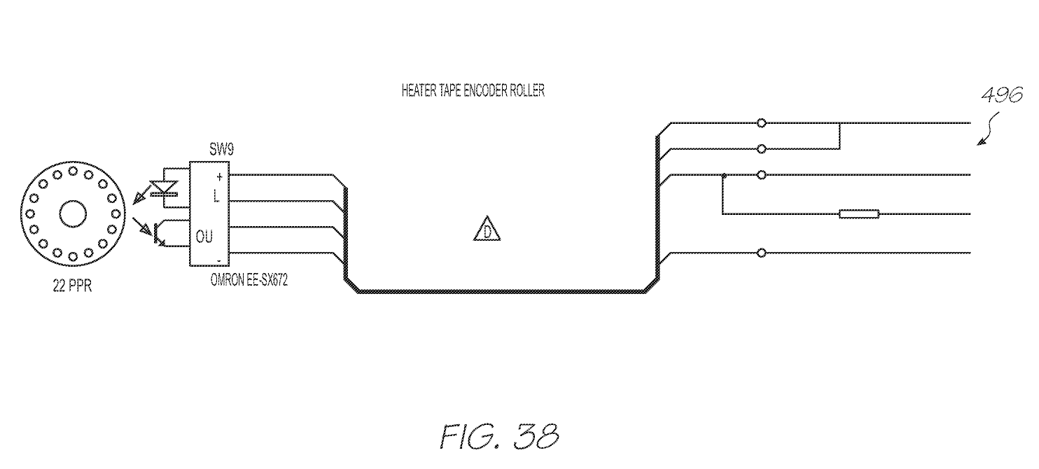

The controller block 26 is connected to receive inputs from the start buttons 44. The controller block 26 is also configured to control operation of the positioning or linear stage actuator 80, the barcode scanner 38, the warning beacon 42, the ultrasonic knife assembly 86 and the grippers 128, 130. The controller block 26 is also configured to control operation of controllers 418, 420, 422 of the liner take up spool 122 and the reel actuators 116, 118, respectively (FIG. 38).

Also shown is a Firewire interface card 172 to interface the PLC 26 with the camera arrangement 76. A fan unit 174 is included to provide cooling and ventilation. The Inventor has found a Sunon 24V DC brushless fan with Papst filter assembly to be suitable for this purpose. A power supply 176 is also included to provide power to the ionizer bar 98 of the lamina supply 20, along with the LED light controller 170, described above. Solenoid valves 166 are shown to control pneumatic elements of the apparatus, specifically the bonding apparatus and a knife assembly, and a network switch 168 to interconnect the PLC FX3U-ENET Ethernet interface module, the flat panel PC 56 and an external RJ45 connector 202 (FIG. 18). Also shown are fuses 164 to provide protection to electrical circuitry of the controller 26.

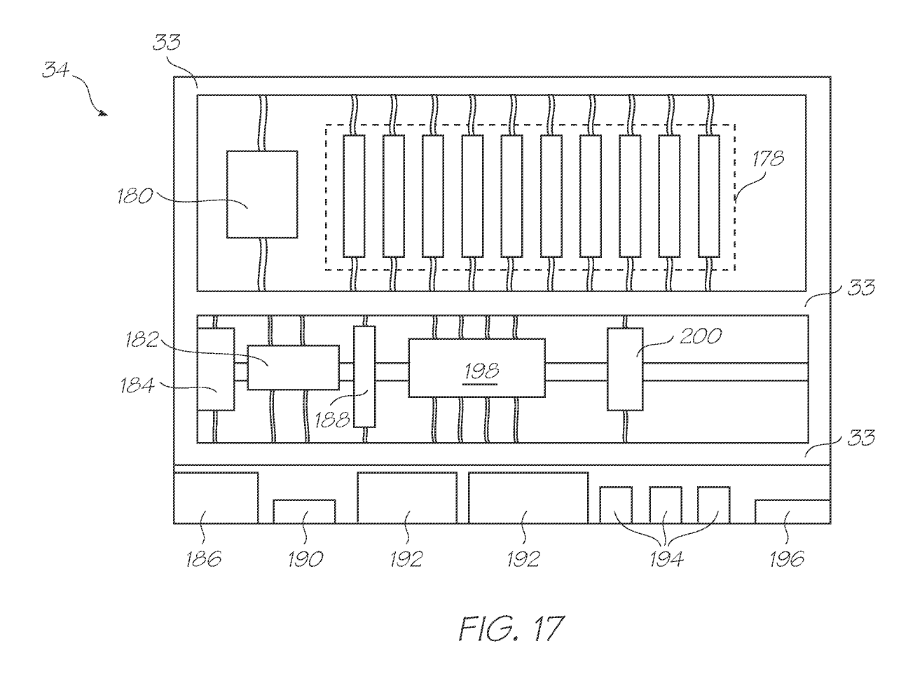

FIG. 17 shows the rear equipment enclosure 34 in an open position with internal components visible. The enclosure 34 also includes trunking 33 through which the necessary electrical and pneumatic connections between components can be established. Motion axis controllers 178 provide an interface between the axis actuators described above with reference to FIG. 14 and the PLC 26. Relays 200 are used on the barcode scanner 38 and the ultrasonic knife assembly 86, described below. Fuses 198 provide additional electrical protection to the electrical components, along with circuit breakers 196, which are Hager AD 810T residual current circuit breakers.

Respective components of the apparatus 16 are supplied with electricity through three power supply units 194. The first unit is a Cosel PBA300F-24 24V DC power supply unit to supply appropriate voltage levels to some of the axis actuators, with a second PBA50F-12 power supply also providing power to some of the axis actuators. A PBA50F-9 power supply unit provides power to the barcode scanner 38, the PC unit 56 and PLC 26, and the LEDs. In this manner, all electrical components are supplied with required voltage levels. Transformers 192 are used to supply the ultrasonic knife 86 with AC current. Transformer 186 is used to supply AC power to some of the axis actuators. A capacitor and bridge rectifier circuit 190 provides filtering and rectification of an input AC supply. Motor contactors 182 are used to control starting of the axis actuators, and circuit breakers 184 provide electrical protection for the contactors 182.

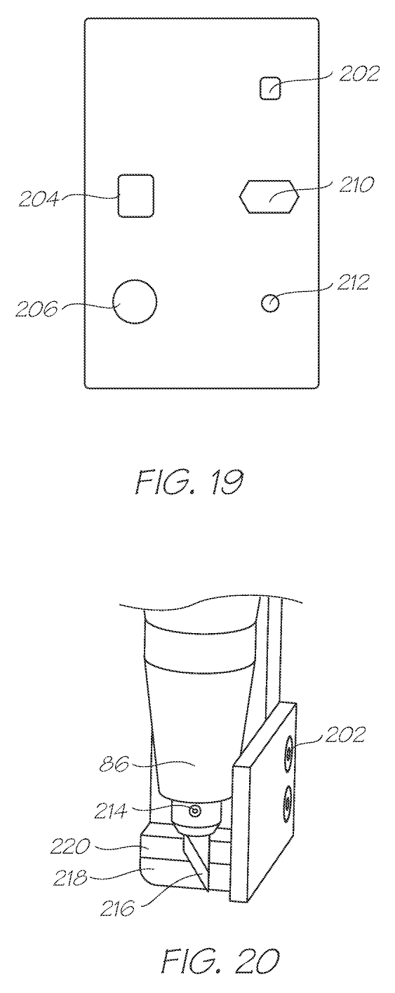

FIG. 18 shows an internal view of the service panel 36. The RJ45 connector 202 can be seen, with which the PLC 26 is arranged in contact with the remote monitoring system. Also shown is an AC mains isolation switch 204 for safety purposes, and a main air isolation valve for the pneumatic components of the apparatus 16. A mist separator 208 is used to filter particles from an incoming air supply of the pneumatic components. FIG. 19 shows an external view of the panel 36, showing an incoming AC mains connector 210, and an incoming air supply connector 212.

As discussed above, the apparatus 16 includes a safety system to ensure safe operation thereof and to minimize damage to the carrier 10 and the apparatus 16, as well as to prevent harm to the operator. As described above, the safety system is typically implemented via the controller 26.

As such, the controller 26 is linked to a number of regulators, as described above, which include sensors for monitoring air pressure. An undesired pressure typically indicates an undesired operational status of the apparatus 16, and the controller 26 can deactivate the tester and its components to prevent damage and/or harm. In addition, the controller 26 is also linked to a number of position sensors to sense positions of movable mechanisms, such as the cradle platform 18, the lamina supply, the alignment mechanism 22, the bonding apparatus 24, etc. A person skilled in the art will appreciate that the controller 26 may be configured to monitor any feature relating to the operational status of the apparatus 16.

### Circuit Diagrams

FIGS. 23 to 38 show circuit diagrams of interconnections between the electrical components described above. It is to be appreciated that the circuit diagrams are described in overview with only some of the connections indicated. The circuit diagrams are meant to assist the skilled person in interpreting the interconnections between the components, and not to provide an exhaustive circuit description. In the circuit diagrams, like reference numerals indicate like connections unless otherwise indicated.

FIG. 23 shows a safety system which forms part of the control system of the apparatus 16. Light curtain sensors 40 are shown, along with a light curtain controller 480 and safety relay 180. Limit switches 490 of the table 21 are indicated, as well as emergency stop buttons 492. The connections from the respective motion axis controllers (collectively indicated by 178 in FIG. 17) 438, 440, 442, 444, 446, and 448 are also shown. These connections are indicated when the respective motion axis controllers are described below. The safety system indicated includes a number of mute connections to the PLC 400 to halt all activity should the safety circuitry be activated. Main pneumatic system venting valves 494 are also indicated. These valves 494 vent air pressure when the safety circuitry is active.

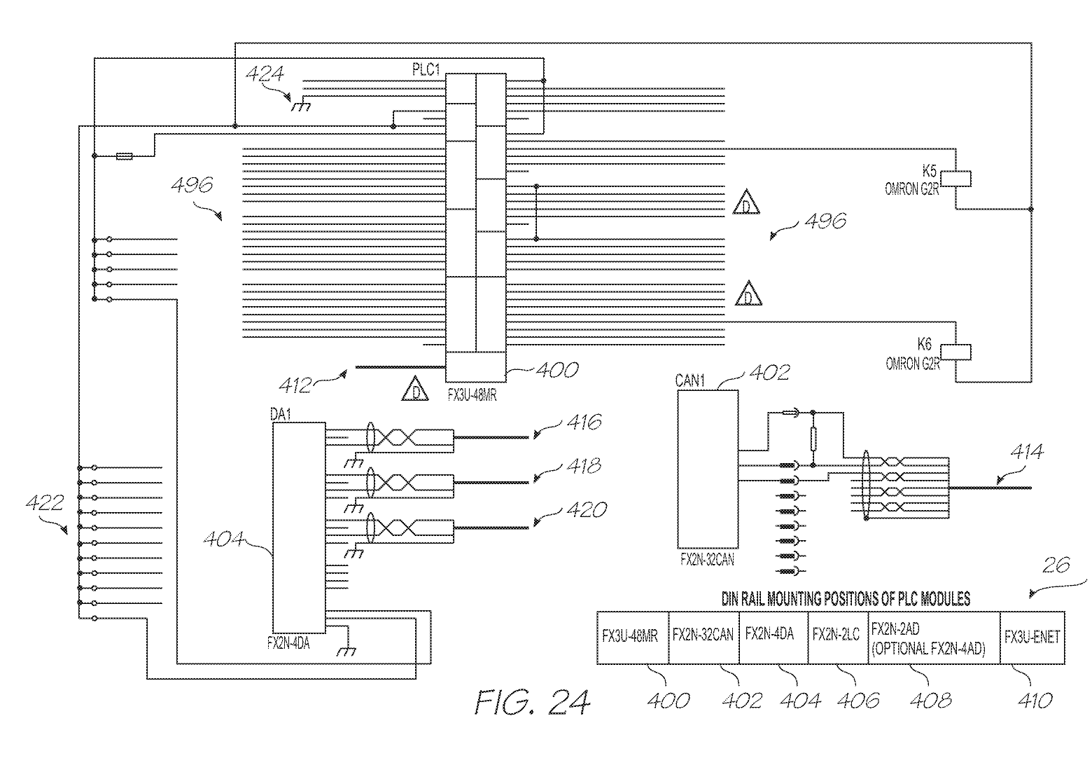

With reference to FIG. 24, a modular PLC controller block 26 is shown. As mentioned above, the PLC block 26 includes the Mitsubishi® FX3U-48MR PLC 400 along with the FX2N-2LC temperature control block 406, a FX2N-4AD analog input module 408, a FX2N-4DA analog output module 404, a FX3U-ENET Ethernet interface module 410, and a FX2N-32CAN controller area network serial bus block 402.

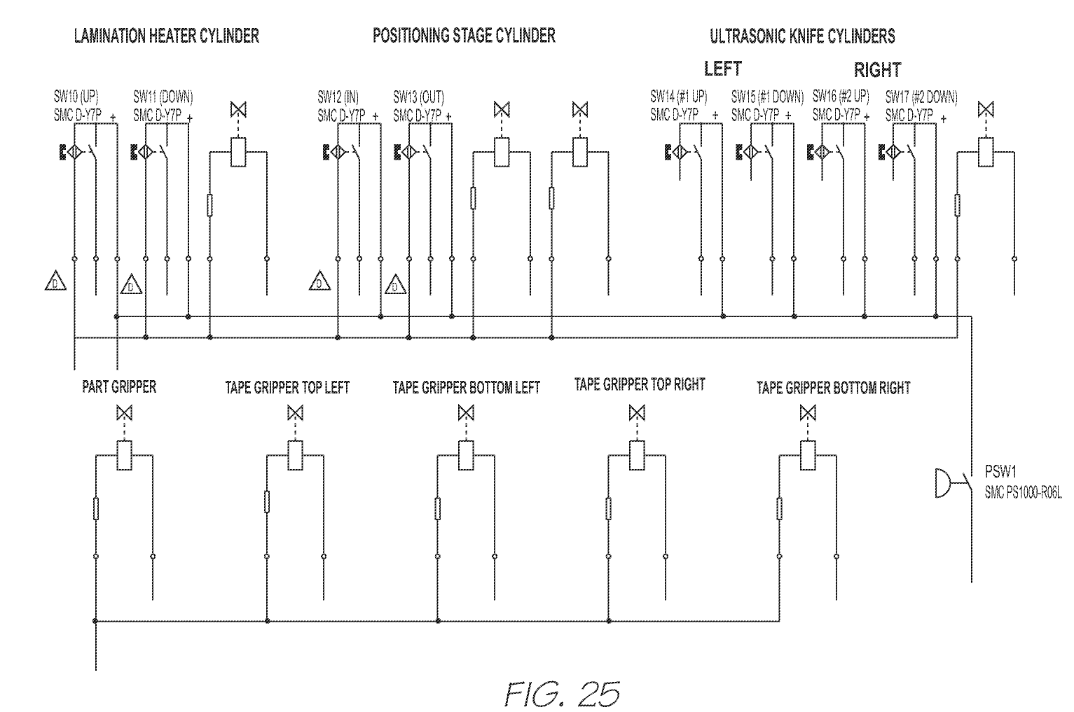

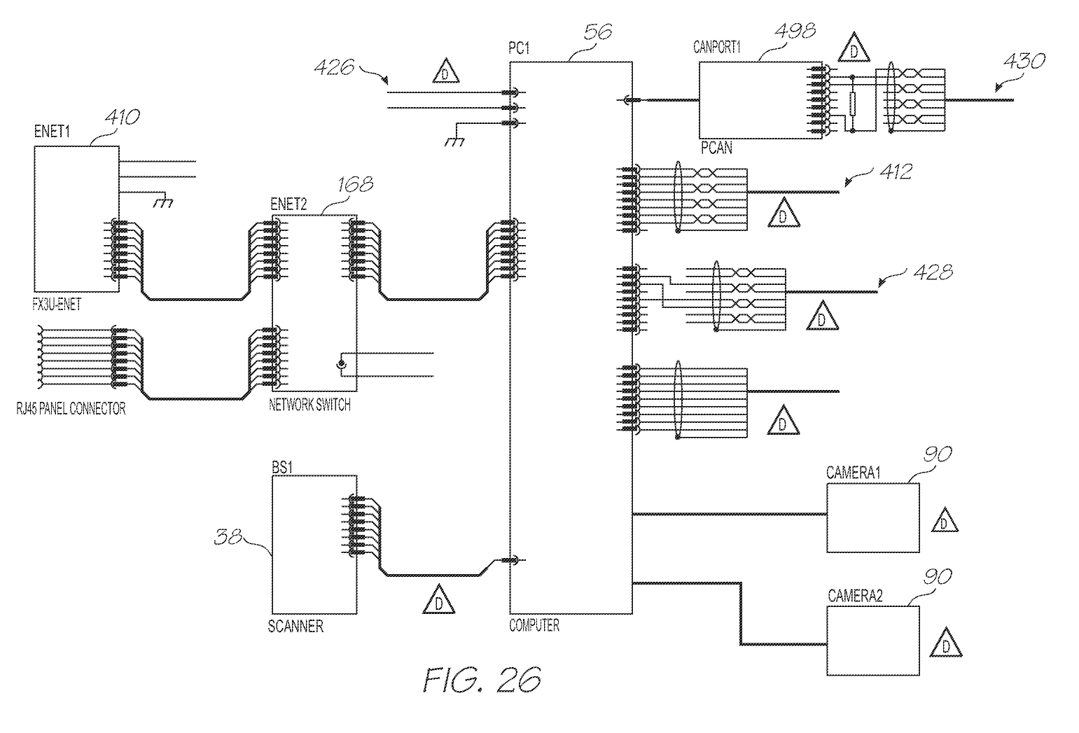

PLC 400 includes power connection 424, along with a plurality of controlling connections (collectively indicated by reference numeral 496) for controlling the respective pneumatic components. FIG. 25 shows the respective pneumatic components controlled by the PLC 400 via the controlling connections 496. Connection 422 indicates a common earth for the control system. The PLC 400 is connected to the PC 56 at connection 412.

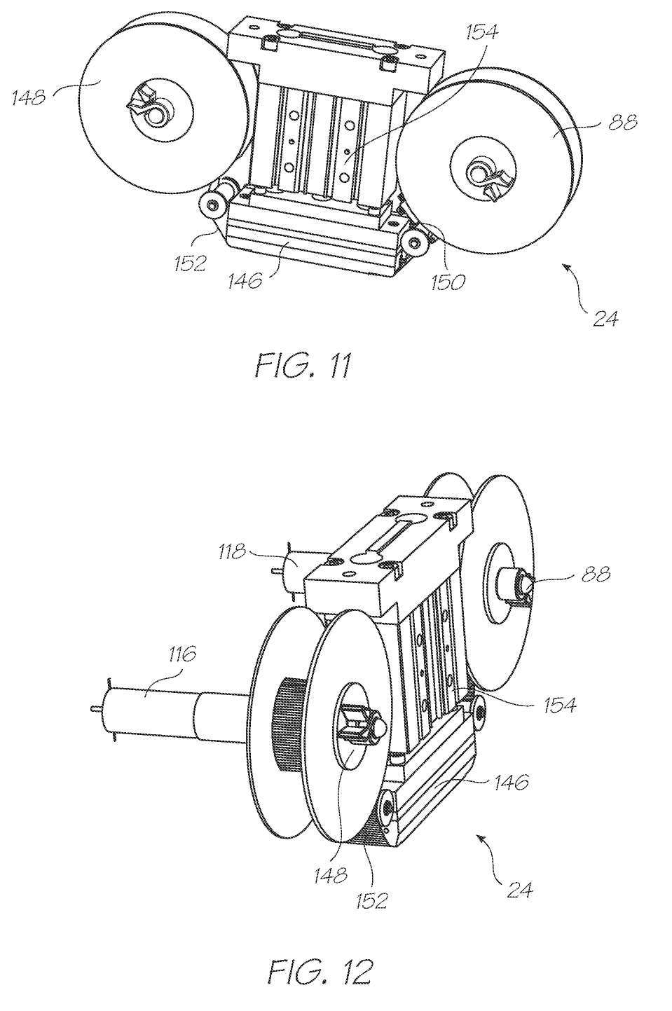

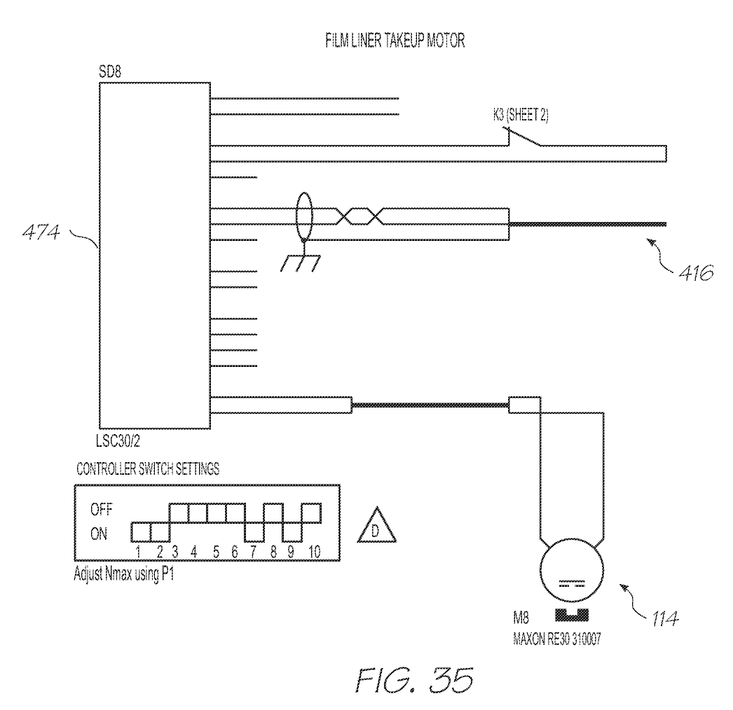

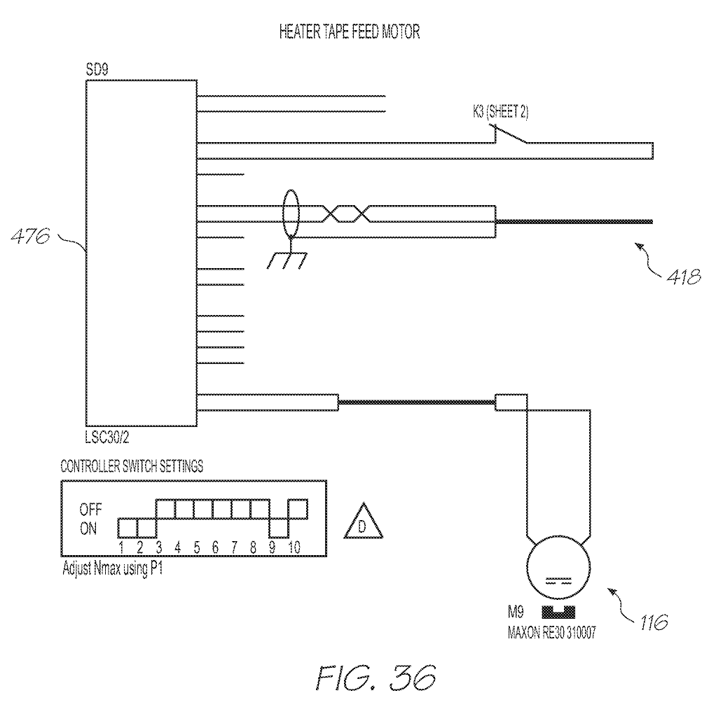

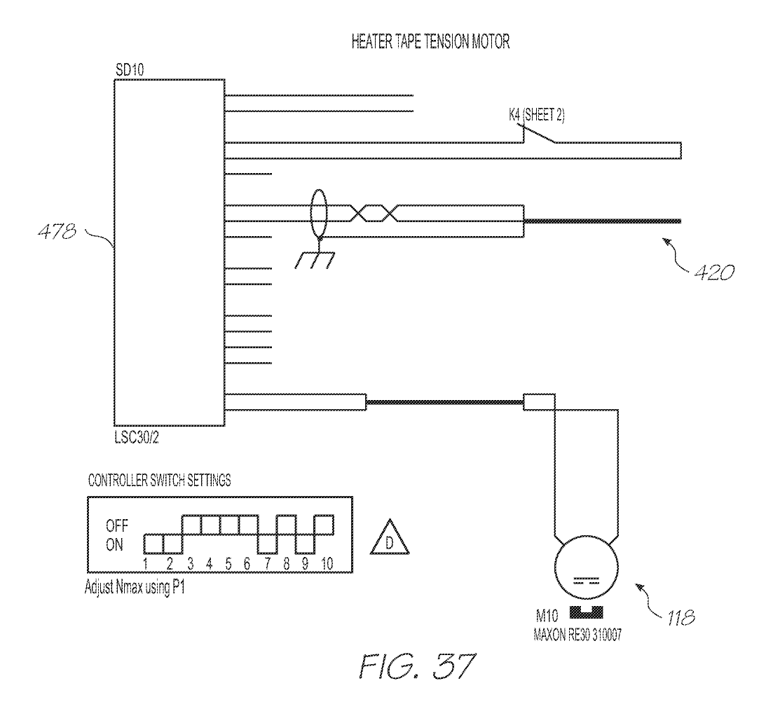

The FX2N-4DA analog output module 404 has connection 416 to motion axis controller 474 (FIG. 35) of drive 114 actuating the take-up spool 122, and connections 418 and 420 to motion axis controller 476 (FIG. 36) and 478 (FIG. 37) of reel actuators 118 and 116 of the conformal tape dispensing assembly (FIG. 12). The FX2N-32CAN controller area network serial bus block 402 forms the interface between the PLC 400 and the motion axis controllers 178 (FIG. 17) via serial connection 414. The motion axis controllers are collectively indicated by reference numeral 178 in FIG. 17. These controllers are shown individually in FIGS. 28 to 37. These controllers are respectively indicated by 436, 462, 464, 466, 468, 470, 472, 474, 476 and 478. All these controllers are serially connected to the PLC 400 via serial bus block 402.

FIG. 26 shows an overview of a network arrangement formed between the PC 56, cameras 90, Ethernet switch 168 and Ethernet module 410 of the PLC block 26. PC 56 is connected to the relevant power supplies, described above, at connection 426. Barcode scanner 38 is also connected to PC 56.

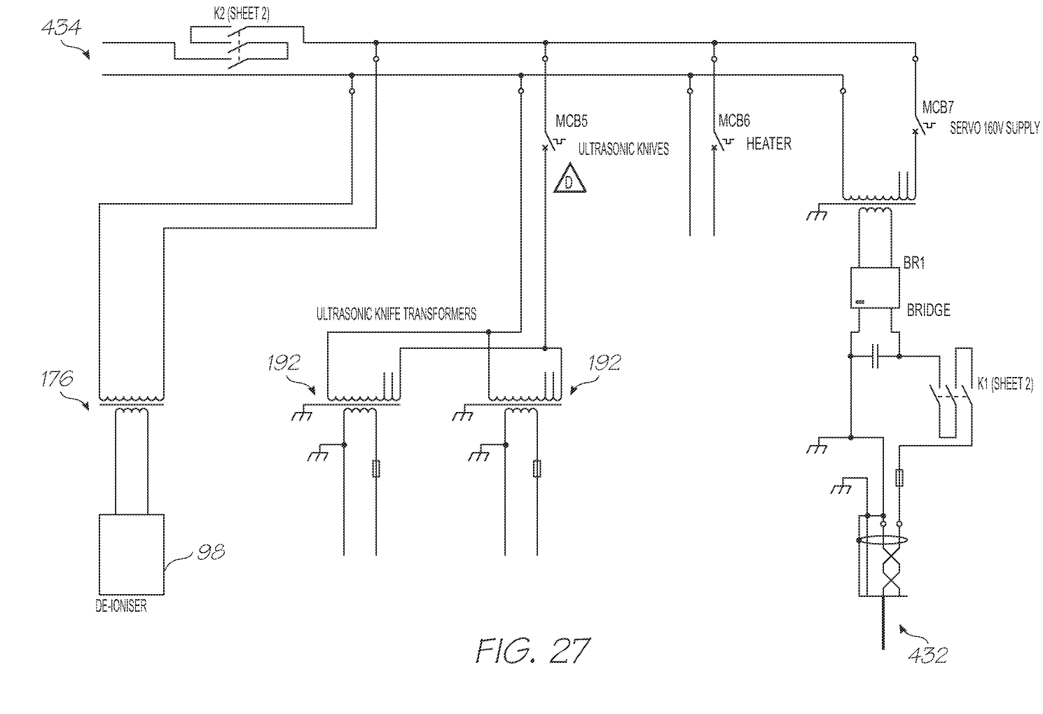

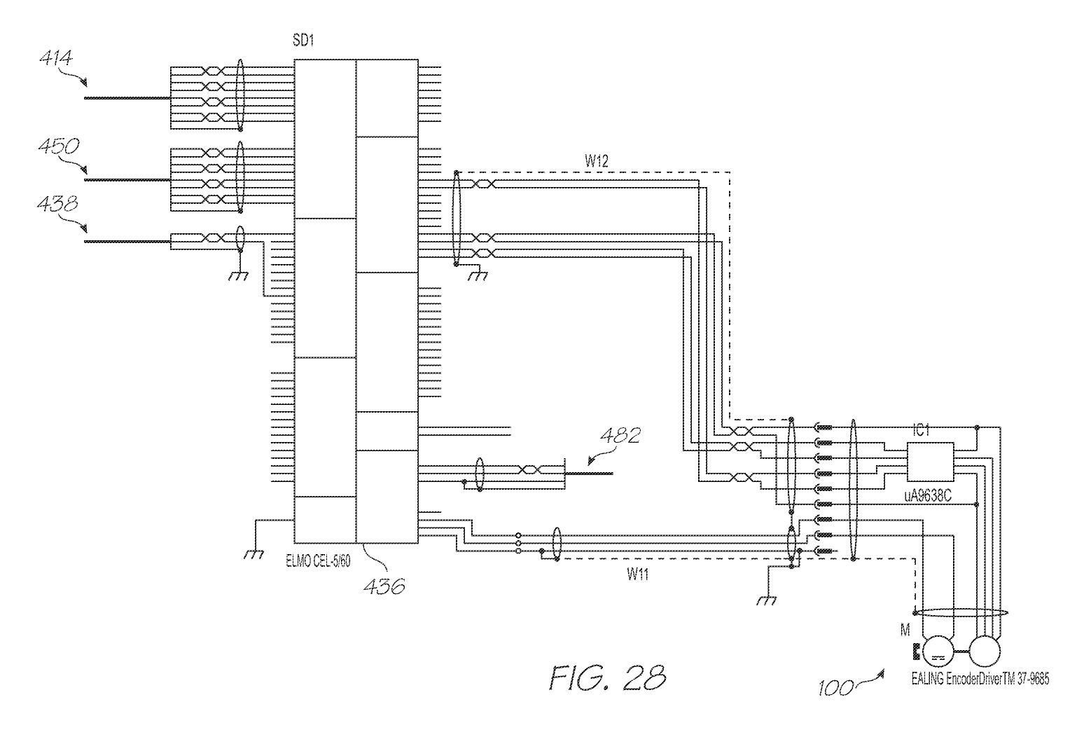

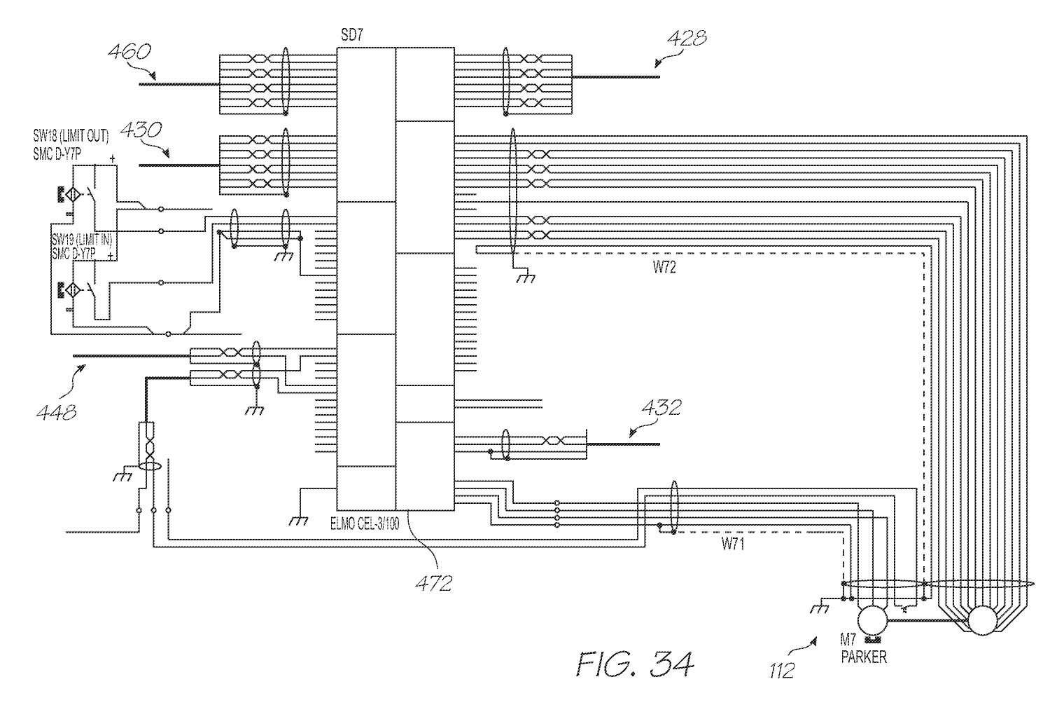

FIG. 27 shows a power circuit of the apparatus 16. Indicated are power connection 434 to the relevant power supply described above, ultrasonic knife transformers 192 and ionizer power supply 176. Power connection 432 to motion axis controller 472 (FIG. 34) is also shown.

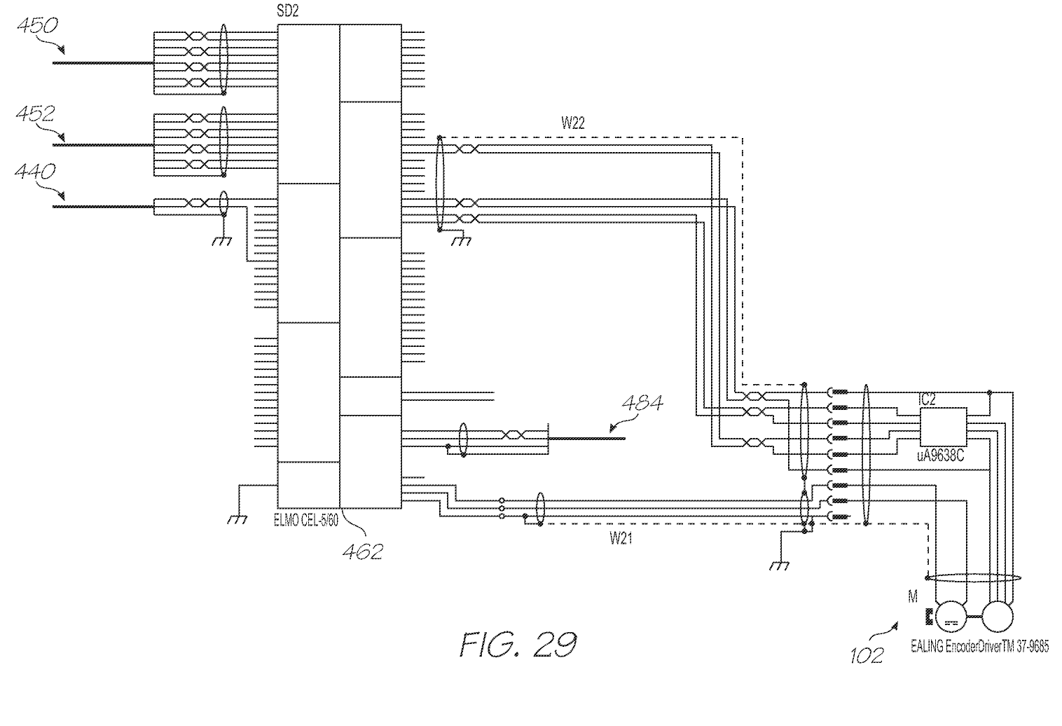

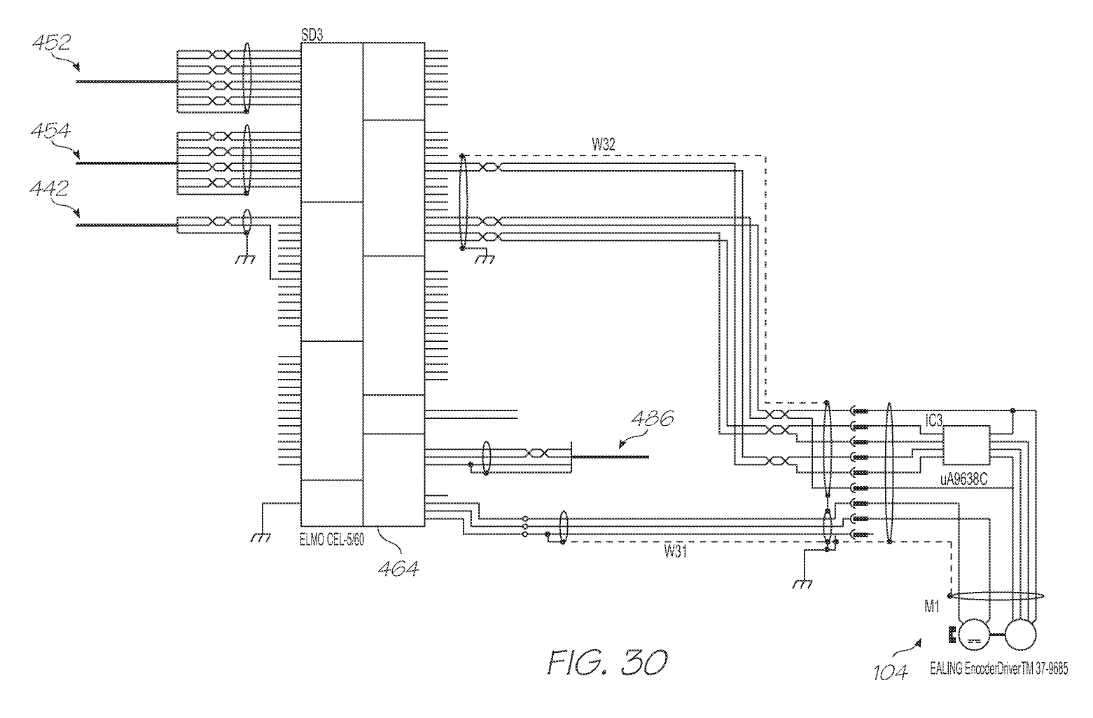

FIG. 28 shows motion axis controller 436 responsible for drive 100, as indicated. Motion axis controller 436 includes serial connection 414 to serial bus block 402 of the PLC block 26, serial connection to the next motion axis controller 462 (FIG. 29), and connection 438 to the safety circuitry of FIG. 23. Also shown is power connection 482 to a power supply of the apparatus 16.

FIG. 29 shows motion axis controller 462 responsible for drive 102, as indicated. Motion axis controller 462 includes serial connection 450 to motion axis controller 436 (FIG. 28), serial connection 452 to the next motion axis controller 464 (FIG. 30), and connection 440 to the safety circuitry of FIG. 23. Also shown is power connection 484 to a power supply of the apparatus 16.

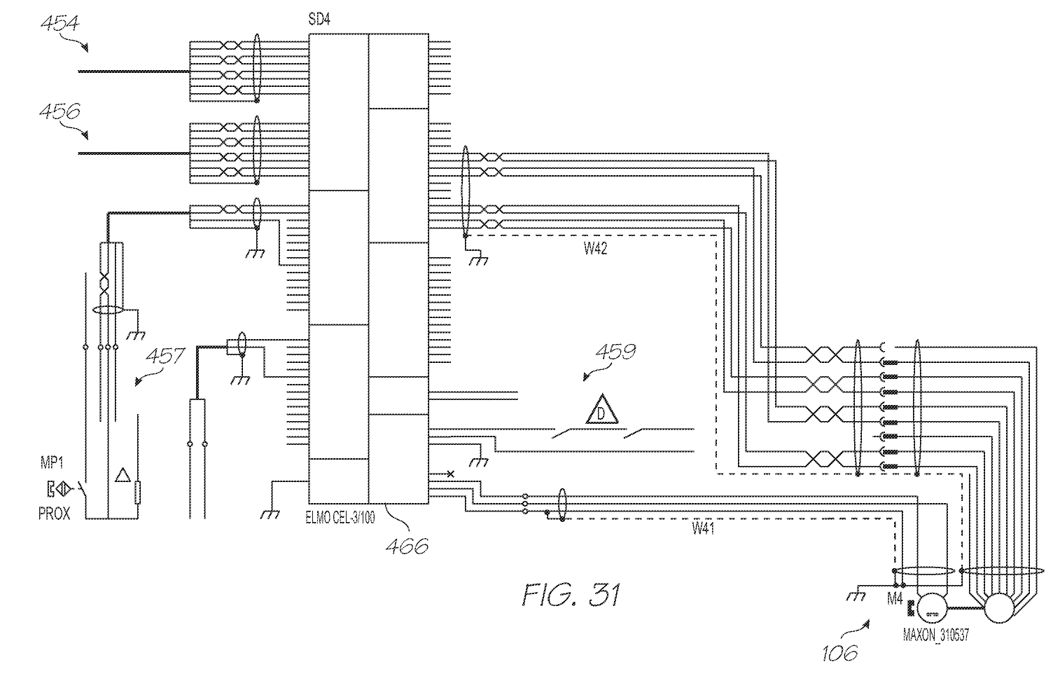

FIG. 30 shows motion axis controller 464 responsible for drive 104, as indicated. Motion axis controller 464 includes serial connection 452 to motion axis controller 462 (FIG. 29), serial connection 454 to the next motion axis controller 466 (FIG. 31), and connection 442 to the safety circuitry of FIG. 23. Also shown is power connection 486 to a power supply of the apparatus 16.

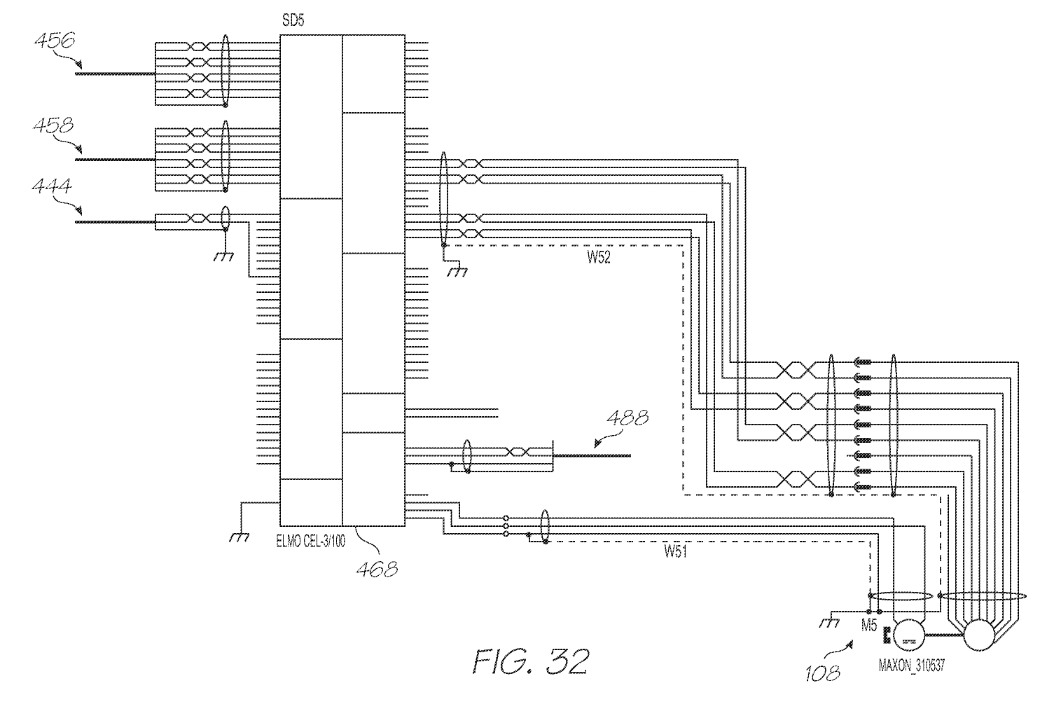

FIG. 31 shows motion axis controller 466 responsible for drive 106, as indicated. Motion axis controller 466 includes serial connection 454 to motion axis controller 464 (FIG. 30), serial connection 456 to the next motion axis controller 468 (FIG. 32), and connection 457 to the safety circuitry of FIG. 23. Also shown is power connection 459 connected to safety circuitry shown in FIG. 23.

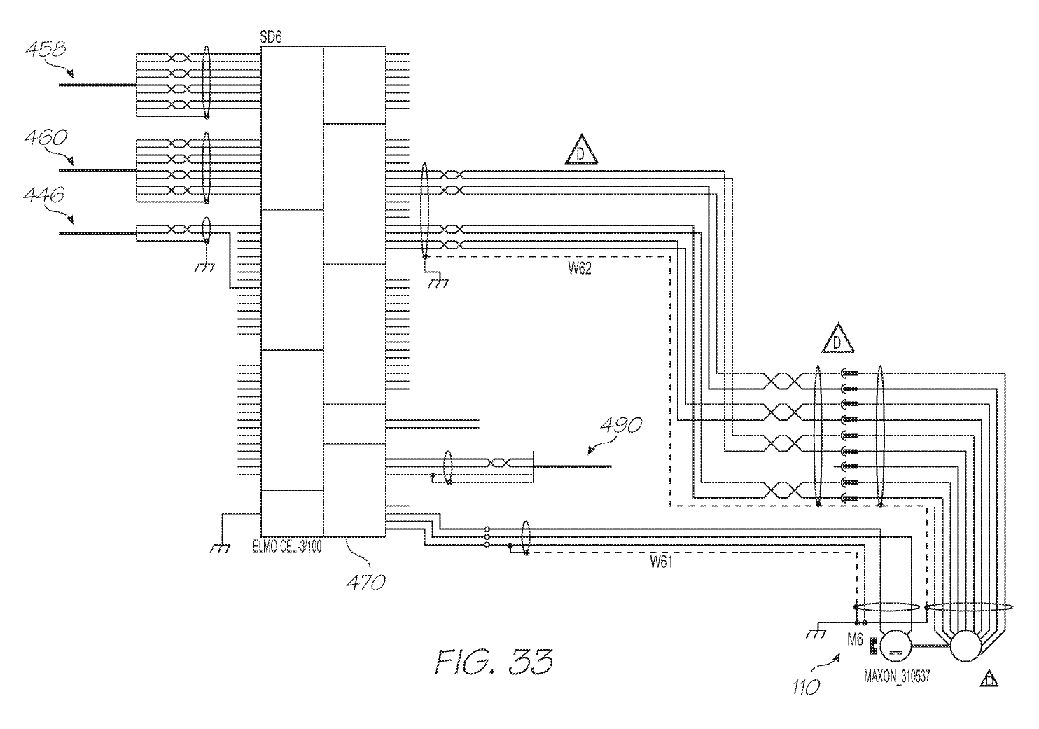

FIG. 32 shows motion axis controller 468 responsible for drive 108, as indicated. Motion axis controller 468 includes serial connection 456 to motion axis controller 466 (FIG. 31), serial connection 458 to the next motion axis controller 470 (FIG. 33), and connection 444 to the safety circuitry of FIG. 23. Also shown is power connection 488 to a power supply of the apparatus 16.

FIG. 33 shows motion axis controller 470 responsible for drive 110, as indicated. Motion axis controller 470 includes serial connection 458 to motion axis controller 468 (FIG. 32), serial connection 460 to the next motion axis controller 472 (FIG. 34), and connection 446 to the safety circuitry of FIG. 23. Also shown is power connection 490 to a power supply of the apparatus 16.

FIG. 34 shows motion axis controller 472 responsible for drive 112, as indicated. Motion axis controller 472 includes serial connections 428 and 430 back to the PC 56 of FIG. 26. Also shown is connection 448 to the safety circuitry of FIG. 23, and power connection 432 to a power supply of the apparatus 16. The motion axis controller 472 of FIG. 34 has a direct feedback connection to PC 56 via a suitable network port 498. Motion axis controller 472 controls actuator 112 responsible for displacing table assembly 21 to move cradle platform 18 from the lamina supply 20 to the alignment mechanism 22 to the bonding apparatus 24. As the alignment mechanism 22 relies on the camera arrangement 76, which is directly connected to PC 56, a direct feedback connection 430 to the PC 56 is necessary to allow the PC to sense when the table assembly is in position. A serial connection 428 also connects the motion axis controller 472 to PC 56, as shown.

FIG. 38 shows an embodiment of an incremental conformal tape sensor connected to PLC 400 via the controlling connections 496.

### Ultrasonic Knife Assembly

The ultrasonic knife assembly 86 is shown in more detail in FIG. 20. The assembly 86 is used by the controller 26 to cut excess lamina film from the carrier 10 after bonding. The assembly 86 includes a blade 216, blade securing screw 214, blade guard 220 with Teflon™ pad 218 and blade guard securing screws 222. The Inventor has found the Alex Corporation KW-430C portable cutters suitable for this application. These cutters are designed to cut the lamina without leaving a residue.

The knife assembly 86 is also controlled by the controller 26. Once the bonding apparatus 24 has successfully bonded the aligned lamina with the carrier, the controller 26 activates the knife assembly to cut the excess lamina from the carrier 10.

### Lamination Method

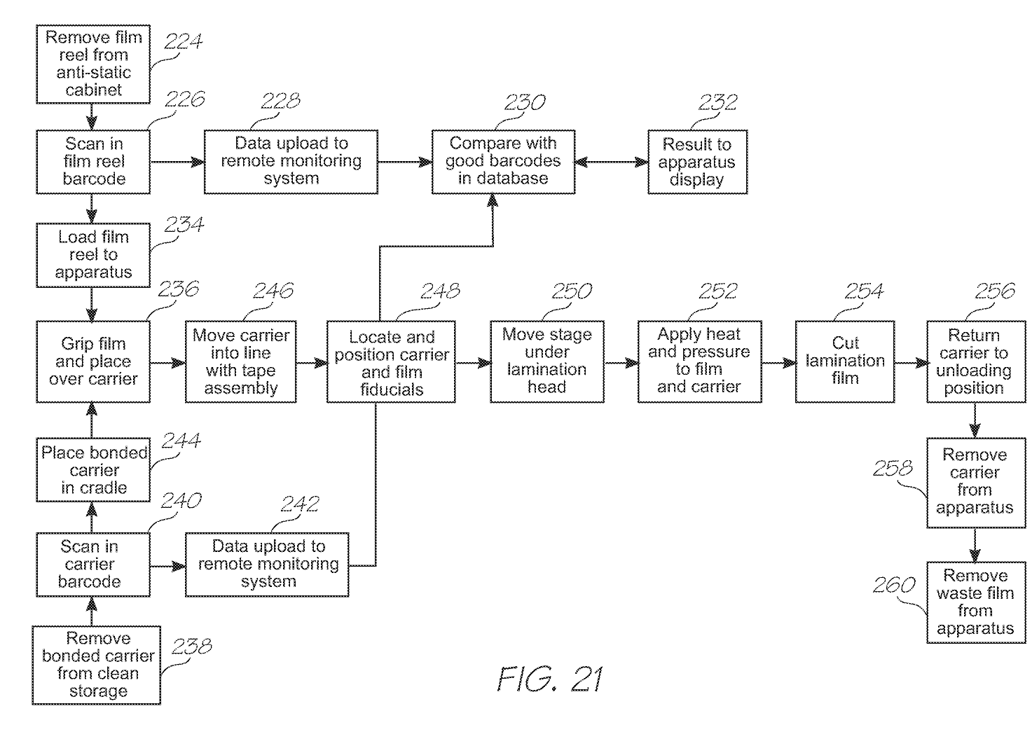

A block diagram of a process or method outline is shown in FIG. 21. It is to be appreciated that reference to a reference numeral representing a particular method step refers to a respective block indicated by such reference numeral in the accompanying drawings. As such, the method included in the invention is not limited or constrained to particular method steps referred to in this manner. A skilled person will understand that further methods are possible under this invention which might exclude some of these steps or include additional steps.

The steps shown are typically performed under one embodiment of the invention, with other embodiments having different steps. In preparation of the bonding process, the operator must make sure that any consumables are present, such as the lamina film. If not, the lamina supply 20 must be refilled. This is done by retrieving a new film reel from a storage cabinet, shown at block 224, scanning a barcode of the new film reel with the barcode scanner 38 (block 226), and loading the reel into the lamina supply (block 234).

The scanning of the barcode of the replacement film reel (block 226) results in communication of this scanned barcode to the remote monitoring system, typically for quality control and assurances purposes. Such a quality control process is shown at blocks 228, 230 and 232 where the barcode is uploaded to the remote monitoring system, compared with known good barcodes, and a result is shown on the display 56. The results so displayed are typically whether or not the barcode scan was successful.

The operator must also load the carrier 10 into the cradle platform 18. The operator removes the carrier 10 from storage (block 238) similarly scans the carrier's barcode (block 240) which is also checked by the remote monitoring system (blocks 242, 230 and 232), and placed on the cradle platform (block 244). Once the controller 26 has verified that the carrier 10 is in place and the lamina supply 20 has film 14, the controller 26 proceeds with automatically aligning the carrier fiducials with the holes in the film.

Block 236 indicates a step of gripping the film with the film gripper 128 and 130 (FIG. 9) and feeding the film over the carrier 10 on the platform 18. The controller 26 then moves the carrier in line with the film fed over the platform 18 by means of the axis actuators, described above with reference to FIG. 14, indicated by block 246.

The controller 26 then uses the camera arrangement 76 to locate the fiducials on the carrier and the holes in the film 14, shown at block 248. Once the fiducials 12 and holes are aligned, the carrier 10 and film is moved under the bonding apparatus, as indicated by block 250. The binding apparatus 24 then applies heat and pressure to bind the film to the carrier 10, as at block 252.

Once the film has been bonded to the carrier, any excess film is removed by the ultrasonic cutter 86, indicated at block 254. The cradle platform 18 is then moved out from under the bonding apparatus 24 (block 256) to an unloading position, so that the operator can remove the bonded carrier 10 at block 258. The operator also removes waste film removed by the cutter 86 from the apparatus 16 at block 260. The removed carrier generally appears as shown in FIG. 2.

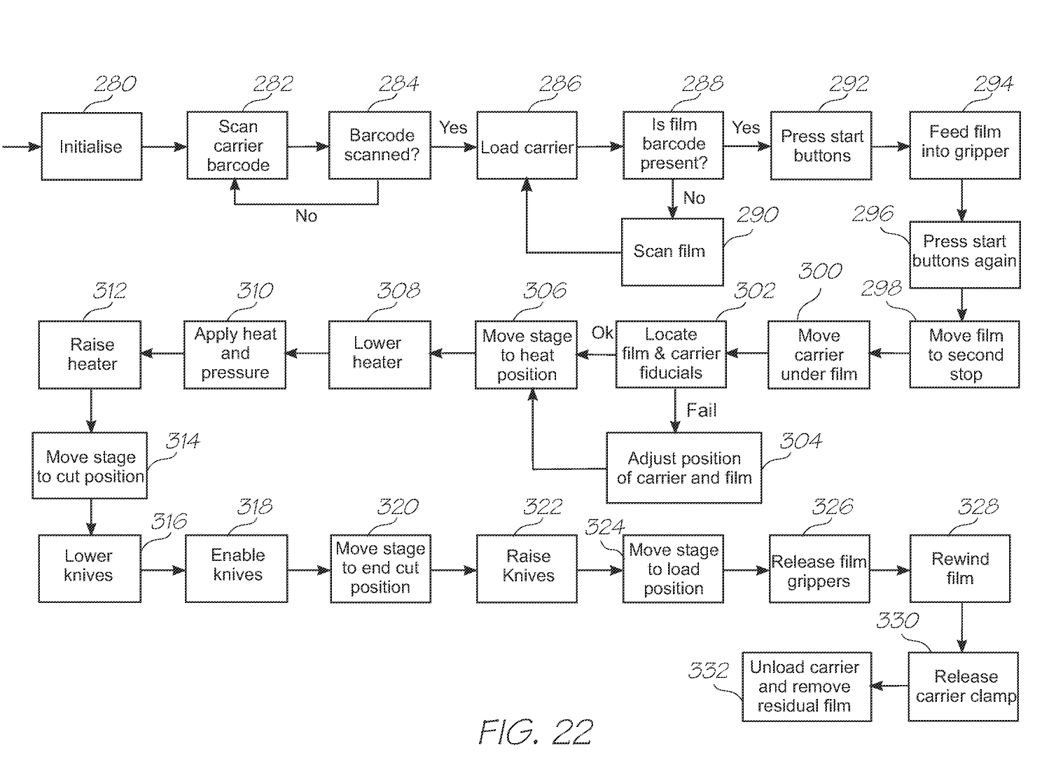

FIG. 22 shows a similar functional block diagram for typical steps performed by the apparatus 16 in one embodiment of the invention. The apparatus initializes (block 280) with the controller 26 performing self-tests and checks whether or not all the electrical and pneumatic components are functioning correctly. A barcode of the carrier is then scanned, as described above (block 282). As indicated at block 284, the barcode scanner 38 keeps scanning until the barcode is successfully scanned.

The operator then proceeds to load the carrier 10 into the cradle platform 18 (block 286). Blocks 288 and 290 show steps for scanning a barcode of the lamina reel 94, so that the remote monitoring system can register which carriers have been laminated with which lamina. This facilitates quality and assurance checks.

If the carrier is loaded and all barcodes have been scanned and sent to the remote monitoring system, the start buttons are activated by the controller 26, so that the operator can press the buttons 44.1 and 44.2 to instruct the apparatus 16 to laminate the lamina film to the loaded carrier. When ready, the operator presses the start buttons 44 (block 292).

The film gripper assembly 96 then feeds the lamina film from reel 94 to film gripper 130, as described above (block 294). The operator then pushes the start button again (block 296), so that the film gripper 130 pulls the lamina film across the cradle 18 (block 298), described above. The controller 26 then operates linear stage actuator 80 to move the carrier in cradle 18 to below the film drawn between film grippers 128 and 130 (block 300).

The controller 26 then uses the camera arrangement 76 to locate the fiducials and apertures of the lamina film and carrier, as described with reference to FIG. 15 above (blocks 302 and 304). Once the fiducials and apertures have been aligned, the table assembly actuator 84, under control of the controller 26, moves the table 21 with the cradle 18 and lamina to the bonding apparatus 24 (block 306).

The controller 26 lowers the laminating head 146 (block 308) to bond the aligned lamina to the carrier 10 with heat and pressure (block 310). After a predetermined time, the controller 26 raises the laminating head 146, as at block 312, via actuator 154.

After bonding, the controller 26 actuates table assembly actuator 84 to move table 21 into a cutting position where the ultrasonic knife assembly 86 can cut the lamina remaining from the carrier (block 314). Once the cradle 18 with carrier is in the cutting position, the controller 26 lowers the knife assembly 86 (block 316) and activates the cutters to cut the remaining lamina (block 318). The controller 26 can move the cradle 18, by means of actuator 84, to expose the cutters to the lamina so that accurate removal of the lamina is facilitated (block 320).

After the excess lamina has been removed from the carrier, the controller raises the knife assembly (block 322) and moves the table 21 and cradle 18 out of the apparatus to enable unloading of the bonded carrier (block 324). Once the cradle 18 with the carrier is in the loading position, the controller 26 releases the film grippers 128 and 130 (block 326) so that any remaining lamina film can be rewound onto reel 94 via the lamina supply mechanism 20, as described above (block 328).

The controller 26 then releases the carrier from the cradle 18 so that the operator can remove the carrier from nest formation 235 and remove any residual film from the apparatus (blocks 330 and 332).

It is to be appreciated that the invention also extends to include a software product for execution by the controller or PLC 26, as described above. The software product enables the PLC 26 to perform the functions and relevant method steps described above. The invention inherently includes a computer readable medium, such as a magnetic or optical disc, incorporating such a software product.

1. An alignment mechanism for aligning a lamination film with a carrier substructure prior to laminating the film to the substructure to form a carrier for integrated circuits, the substructure and the lamination film defining complementary perforations and a plurality of respective fiducials, said alignment mechanism comprising:
a sensor arrangement configured to detect the fiducials in the lamination film and substructure;
a displacement mechanism configured to displace the lamination film with respect to the substructure to align the perforations of the film and substructure respectively according to alignment of their fiducials so that a printing fluid can pass through the perforations in the film and the substructure of the carrier; and
a controller configured to control operation of the sensor arrangement and the displacement mechanism.

2. The alignment mechanism of claim 1, wherein the displacement mechanism includes actuators configured to displace the substructure relative to the lamination film along at least two axes.

3. The alignment mechanism as claimed in claim 2, in which the actuators are in the form of a number of linear actuators that operatively engage the substructure to displace it along one axis and a number of linear actuators that operatively engage the lamination film to displace it along an orthogonal axis.

4. The alignment mechanism of claim 1, wherein the sensor arrangement includes a digital camera and lens arrangement in signal communication with the controller for identifying the fiducials.

5. The alignment mechanism as claimed in claim 3, in which the digital camera and lens arrangement is configured to identify fiducials in the form of complementary openings defined in the substructure and the lamination film.

6. The alignment mechanism of claim 1, which includes an operator interface operatively connected to the controller and configured to receive displacement instructions from an operator.

7. The alignment mechanism of claim 1, wherein the displacement mechanism is configured to displace the lamina or carrier incrementally relative to the carrier or lamina, respectively.
